(19) United States
(12) Patent Application Publication
(10) Pub. No.: US 2019/0111688 A1
(43) Pub. Date: Apr. 18, 2019

(54) PRINTER, PRINTING METHOD, AND INK JET HEAD

(71) Applicant: Seiko Epson Corporation, Tokyo (JP)

(72) Inventors: Kinya OZAWA, Shirojiri-Shi (JP); Seiichi TANIGUCHI, Asahi-mura (JP); Hidenori USUDA, Matsumoto-shi (JP); Yasumasa NAKAJIMA, (US)

(21) Appl. No.: 16/089,867

(22) PCT Filed: Mar. 22, 2017
(86) PCT No.: PCT/JP2017/011417

§ 371 Date: Sep. 28, 2018

(30) Foreign Application Priority Data
Mar. 29, 2016 (JP) 2016-065162
Mar. 29, 2016 (JP) 2016-065163
Mar. 29, 2016 (JP) 2016-065164

(51) Int. Cl. B41J 2/175; B41J 2/17

(52) U.S. Cl. CPC B41J 2/175; B41J 2/15; B41J 2202/02; B41J 2/1707

(57) ABSTRACT

To provide a printer that can suppress self-jet generated by ejection of ink from a nozzle row and can improve printing quality.

A printer includes an ink jet head 11 that ejects liquid from a nozzle row 14 being open in a liquid ejection surface 12 arranged on a surface facing a printing medium 3; a plasma actuator 20; and a controller 30 that controls the ink jet head 11 and the plasma actuator 20. When the nozzle row 14 ejects liquid to the printing medium 3, the controller 30 drives the plasma actuator 20 to generate an airflow between the liquid ejection surface 12 and the printing medium 3.

### TECHNICAL FIELD

The present invention relates to a printer, a printing method, and an ink jet head.

### BACKGROUND ART

Hitherto, an ink jet printer that performs printing by ejecting ink is known.

In such a printer, with an ink jet head having a high-density nozzle row of either type of serial type and line type, a vortex (swirl) is generated due to an airflow that is generated by ejection of ink from the nozzle row.

When a vortex is generated, landing positions of flying liquid droplets are deviated, and an irregular print called a wind ripple is generated on a printing medium, resulting in a decrease in printing quality.

Owing to this, there is a technology provided with a fan that generates an airflow between a nozzle plate and a medium to restrict a vortex that is generated by an airflow formed due to ejection of liquid droplets ejected from a nozzle opening toward a printing medium (for example, see PTL 1).

In such a printer, with an ink jet head having a high-density nozzle row of either type of serial type and line type, the air moves with movement of a carriage or a printing medium, and hence landing positions of flying liquid droplets are deviated.

Owing to this, a technology is disclosed that controls a turbulence by suction and hence improves landing precision (for example, see PTL 2). Also, a technology is disclosed that controls an airflow by attaching straightening vanes of a head and hence improves landing precision (for example, see PTL 3).

### CITATION LIST

### Patent Literature

PTL 1: Japanese Unexamined Patent Application Publication No. 2014-188925
PTL 2: Japanese Unexamined Patent Application Publication No. 2011-201090
PTL 3: Japanese Unexamined Patent Application Publication No. 2005-205785

### SUMMARY OF INVENTION

### Technical Problem

However, the related art requires a large-scale airflow generating device, and thus the size of the printer is increased.

The invention is made in light of the situations, and an object of the invention is to provide a printer, a printing method, and an ink jet head that can improve printing quality by restricting a turbulence generated due to movement of the air with movement of a carriage or a printing medium, and a vortex generated due to injection of ink.

### Solution to Problem

To attain the object, a printer according to the invention includes an ink jet head that ejects liquid from a nozzle row being open in a liquid ejection surface arranged on a surface facing a printing medium; a plasma actuator; and a controller that controls the ink jet head and the plasma actuator. When the nozzle row ejects liquid to the printing medium, the controller drives the plasma actuator to generate an airflow between the liquid ejection surface and the printing medium.

With this configuration, by driving the plasma actuator and generating an airflow between the liquid ejection surface and the printing medium, a vortex generated when the liquid is ejected from the nozzle row can be suppressed. Consequently, generation of a wind ripple on the printing medium can be reduced, and printing quality can be improved.

According to the invention, the ink jet head is a serial-type ink jet head mounted on a carriage that reciprocates in a main-scanning direction.

With this configuration, with the serial-type ink jet head mounted on the carriage that reciprocates in the main-scanning direction, a vortex generated when liquid is ejected from the nozzle row can be suppressed.

According to the invention, the plasma actuator is arranged beside the nozzle row in a movement direction of the ink jet head.

With this configuration, with the plasma actuator, an airflow can be generated between the liquid ejection surface and the printing medium on both sides of the serial-type nozzle row, and hence a vortex generated when the liquid is ejected from the nozzle row can be suppressed.

According to the invention, the plasma actuator is arranged beside the nozzle row in a direction intersecting with a movement direction of the ink jet head.

With this configuration, with the plasma actuator, an airflow can be generated between the liquid ejection surface and the printing medium on both ends of the serial-type nozzle row, and hence a vortex generated when the liquid is ejected from the nozzle row can be suppressed.

According to the invention, the ink jet head has a side surface intersecting with the liquid ejection surface, the plasma actuator is arranged on the side surface in a movement direction of the ink jet head, and when the nozzle row ejects the liquid, the controller drives the plasma actuator to generate an airflow in a direction from the ink jet head toward the printing medium.

With this configuration, the plasma actuator arranged on the side surface in the movement direction of the ink jet head can generate an airflow toward the printing medium, and an air curtain can be formed at the side surfaces in the movement direction of the ink jet head.

According to the invention, the ink jet head is a line-type ink jet head extending in a direction intersecting with a transport direction of the printing medium.

With this configuration, in the line-type ink jet head extending in the direction intersecting with the transport direction of the printing medium, a vortex generated when the liquid is ejected from the nozzle row can be suppressed.

According to the invention, the plasma actuator is arranged beside the nozzle row in a transport direction of the printing medium.

With this configuration, with the plasma actuator, an airflow can be generated between the liquid ejection surface and the printing medium on both sides of the line-type nozzle row, and hence a vortex generated when the liquid is ejected from the nozzle row can be suppressed.

According to the invention, the plasma actuator is arranged beside the nozzle row in a direction intersecting with the transport direction of the printing medium.

With this configuration, with the plasma actuator, an airflow can be generated between the liquid ejection surface and the printing medium on both ends of the line-type nozzle row, and hence a vortex generated when the liquid is ejected from the nozzle row can be suppressed.

According to the invention, the plasma actuator includes a plurality of plasma actuators.

With this configuration, since the plurality of plasma actuators are arranged, only a plasma actuator corresponding to a nozzle hole that ejects the liquid can be driven.

According to the invention, the line-type ink jet head is configured such that a plurality of unit ink jet heads are arranged in a staggered manner.

With this configuration, even when the line-type ink jet head is configured such that the unit ink jet heads are arranged in a staggered manner, a vortex generated when the liquid is ejected from the nozzle row of each unit ink jet head can be suppressed.

According to the invention, the plasma actuator is arranged for each of the unit ink jet heads.

With this configuration, the plasma actuators can be driven on the unit ink jet head basis, and hence a vortex generated when the liquid is ejected from the nozzle row of each ink jet head can be suppressed.

According to the invention, the ink jet head has a side surface intersecting with the liquid ejection surface, the plasma actuator is arranged on the side surface in the transport direction of the printing medium, and when the nozzle row ejects the liquid, the controller drives the plasma actuator to generate an airflow in a direction from the ink jet head toward the printing medium.

With this configuration, since the plasma actuator can generate an airflow toward the printing medium at the side surface in the transport direction of the printing medium, an air curtain can be formed.

According to the invention, the plasma actuator is arranged at a position at a distance larger than a distance between the liquid ejection surface and a recording surface of the printing medium.

With this configuration, an airflow can be generated between the liquid ejection surface and the printing medium at the position separated from the liquid ejection surface, and hence a vortex generated when the liquid is ejected from the nozzle rows can be suppressed.

According to the invention, the printer further includes a driving voltage generator that generates a driving voltage for driving the plasma actuator, and the driving voltage generator is mounted on the ink jet head.

With this configuration, the driving voltage for the plasma actuator that is driven with a high voltage can be generated by the driving voltage generator. Thus, high voltage wiring is not required to be arranged in a flexible cable or the like, and a problem does not arise in insulation, countermeasure for short-circuit, and countermeasure for noise.

According to the invention, the ink jet head includes wiring for supplying an ink jet driving voltage for driving the ink jet head, and the driving voltage generator generates a voltage for driving the plasma actuator by using the ink jet driving voltage supplied via the wiring.

With this configuration, since the voltage for driving the plasma actuator is generated by using the ink jet driving voltage supplied from the wiring, wiring dedicated for the plasma actuator is not required to be arranged.

According to the invention, the controller individually controls the plurality of plasma actuators to drive a plasma actuator corresponding to a nozzle that is included in the nozzle row and that ejects the liquid.

With this configuration, since the plurality of plasma actuators are individually controlled, a plasma actuator corresponding to a nozzle hole that ejects the liquid can be driven.

According to the invention, the plasma actuator is mounted on the ink jet head.

With this configuration, since the plasma actuator and the ink jet head can be configured as a unit, the printer is simply configured, and easily manufactured.

According to the invention, the plasma actuator is arranged separately from the ink jet head.

With this configuration, since the plasma actuator is provided separately from the ink jet head, a large-scale airflow generating device is not additionally required, and facilitation cost can be reduced.

A printing method according to the invention includes, when a nozzle row being open in a liquid ejection surface of an ink jet head ejects liquid to a printing medium, driving a plasma actuator to generate an airflow between the liquid ejection surface and the printing medium.

With this configuration, by driving the plasma actuator and generating an airflow between the liquid ejection surface and the printing medium, a vortex generated when the liquid is ejected from the nozzle row can be suppressed. Consequently, generation of a wind ripple on the printing medium can be reduced, and printing quality can be improved.

An ink jet head according to the invention includes a liquid ejection surface arranged on a surface facing a printing medium; a nozzle row that is open in the liquid ejection surface, and that ejects liquid to the printing medium; and a plasma actuator. When the nozzle row ejects the liquid to the printing medium, the plasma actuator generates an airflow between the liquid ejection surface and the printing medium.

With this configuration, by driving the plasma actuator and generating an airflow between the liquid ejection surface and the printing medium, a vortex generated when the liquid is ejected from the nozzle row can be suppressed. Consequently, generation of a wind ripple on the printing medium can be reduced, and printing quality can be improved.

### BRIEF DESCRIPTION OF DRAWINGS

FIG. 1 schematically illustrates a serial-type printer according to a first embodiment.

FIG. 2 is a schematic illustration of an ink jet head.

FIG. 3 is a schematic illustration when viewed from a liquid ejection surface in FIG. 2.

FIG. 4 is a cross-sectional view illustrating a basic structure of a plasma actuator.

FIG. 5 illustrates an example in which plasma actuators are arranged in an intersection direction.

FIG. 6 illustrates an example in which plasma actuators are mounted on a carriage.

FIG. 7 illustrates a modification of an arrangement structure of the plasma actuators.

FIG. 8 is a block diagram illustrating a functional configuration of the printer.

FIG. 9 is a timing chart illustrating driving timings.

FIG. 10 is a schematic illustration of an ink jet head for full-color printing.

FIG. 11 is a schematic illustration when viewed from a liquid ejection surface in FIG. 10.

FIG. 12 schematically illustrates a serial-type printer according to a second embodiment.

FIG. 13 is a schematic illustration of an ink jet head.

FIG. 14 is a schematic illustration when viewed from a liquid ejection surface in FIG. 13.

FIG. 15 illustrates an example in which plasma actuators are arranged in an intersection direction.

FIG. 16 illustrates an example of an arrangement of unit ink jet heads.

FIG. 17 illustrates an example of an arrangement of a plurality of plasma actuators.

FIG. 18 schematically illustrates a serial-type printer according to a third embodiment.

FIG. 19 is a schematic illustration of an ink jet head.

FIG. 20 is a schematic illustration when viewed from a liquid ejection surface in FIG. 19.

FIG. 21 illustrates an example in which plasma actuators are arranged in an intersection direction.

FIG. 22 is a schematic illustration of an ink jet head for full-color printing.

FIG. 23 is a schematic illustration when viewed from a liquid ejection surface in FIG. 22.

FIG. 24 schematically illustrates a line-type printer according to a fourth embodiment.

FIG. 25 is a schematic illustration of an ink jet head.

FIG. 26 is a schematic illustration when viewed from a liquid ejection surface in FIG. 25.

FIG. 27 illustrates an example in which plasma actuators are arranged in an intersection direction.

FIG. 28 illustrates an example of an arrangement of unit ink jet heads.

FIG. 29 illustrates an example of an arrangement of a plurality of plasma actuators.

FIG. 30 schematically illustrates a printer according to a fifth embodiment.

FIG. 31 is a schematic illustration of an ink jet head.

FIG. 32 is a schematic illustration when viewed from a liquid ejection surface in FIG. 31.

FIG. 33 illustrates an example of generating airflows in a direction opposite to a movement direction of a carriage.

FIG. 34 illustrates an example of generating airflows away from the ink jet head.

FIG. 35 illustrates an example of generating airflows during flushing.

FIG. 36 illustrates an example in which unit plasma actuators are arranged.

FIG. 37 is a timing chart illustrating driving timings during multiple printing.

FIG. 38 is a schematic illustration of a printer according to a sixth embodiment.

FIG. 39 is a schematic illustration of a printer according to a seventh embodiment.

FIG. 40 is a schematic illustration of an ink jet head according to the seventh embodiment.

FIG. 41 is a schematic illustration when viewed from a liquid ejection surface in FIG. 40.

FIG. 42 illustrates an example of generating airflows away from the ink jet head.

FIG. 43 illustrates an example of generating airflows during flushing.

FIG. 44 illustrates an example in which unit plasma actuators are arranged.

### DESCRIPTION OF EMBODIMENTS

Embodiments of the invention are described below with reference to the drawings.

### First Embodiment

A first embodiment of the invention is described.

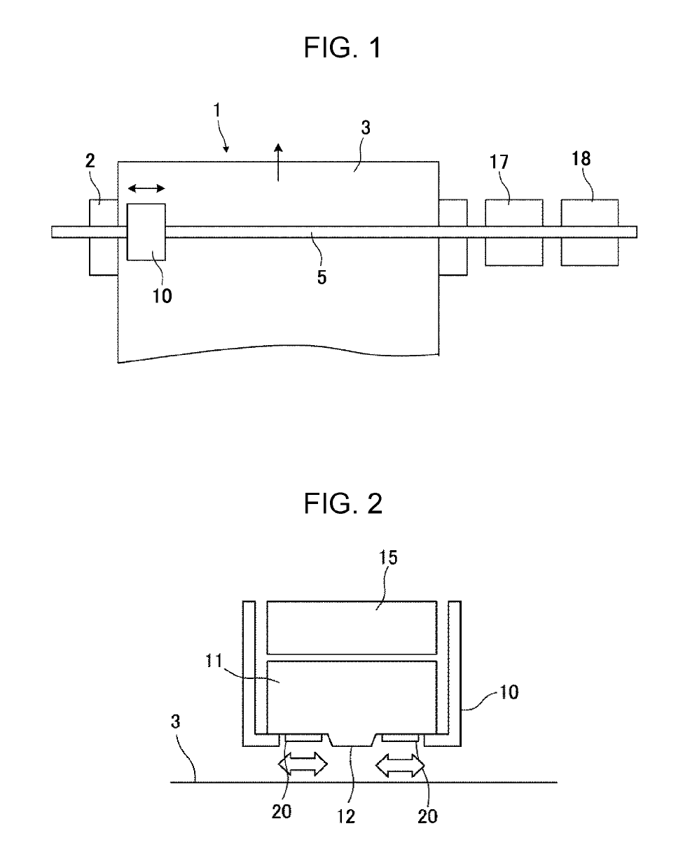

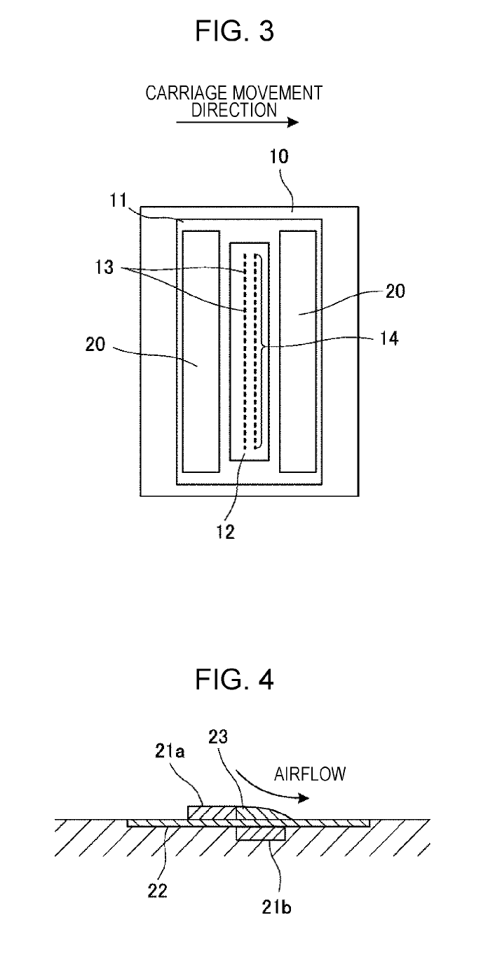

FIG. 1 is a schematic illustration of a printer according to the first embodiment. FIG. 2 is a schematic illustration of an ink jet head of the printer according to the first embodiment. FIG. 3 is a schematic illustration when viewed from a liquid ejection surface in FIG. 2. Described in the first embodiment is a case where a serial-type ink jet head mounted on a carriage that reciprocates in a main-scanning direction is used as an ink jet head.

As illustrated in FIG. 1, a printer 1 includes a flat-plate-shaped platen 2. A predetermined printing medium 3 is transported on an upper surface of the platen 2 in a sub-scanning direction by a paper feed mechanism (not illustrated). The platen 2 may be provided with an ink discarding region for no-margin printing.

The printing medium 3 may be rolled paper wound in a roll form, a cut sheet cut into a sheet with a predetermined length, and a continuous sheet in which a plurality of sheets are joined. Such a recording medium may be paper, such as normal paper, tracing paper, or thick paper; or a sheet such as one made of synthetic resin. Such a sheet treated with coating or dipping may be also used. Regarding the form of a cut sheet, for example, a standard-sized cut sheet, such as PPC paper or a postcard; a booklet form of a plurality of bound sheets such as a bankbook; or a bag-shaped object such as an envelope may be exemplified. Regarding the form of a continuous sheet, for example, continuous paper having sprocket holes in both end portions in a width direction and folded every predetermined length may be exemplified.

A guide shaft 5 that extends in a direction orthogonal to a transport direction of the printing medium 3 is provided above the platen 2. A carriage 10 is provided on the guide shaft 5 so that the carriage 10 can be driven to reciprocate along the guide shaft 5 via a driving mechanism (not illustrated).

As illustrated in FIG. 2, an ink jet head 11 is mounted on the carriage 10. A surface of the ink jet head 11 facing the platen 2 is a liquid ejection surface 12. As illustrated in FIG. 3, the liquid ejection surface 12 has a nozzle row 14 being open in the liquid ejection surface 12. The nozzle row 14 includes a plurality of nozzle holes 13 that eject liquid, for example, ink on the printing medium 3.

In this embodiment, the nozzle row 14 includes two nozzle rows 14 formed in parallel to each other.

The ink jet head 11 includes a driving element 36 (see FIG. 8) such as a piezoelectric element for ejecting liquid from each of the nozzle holes 13. Also, an ink cartridge 15 that supplies the ink jet head 11 with ink is mounted on the carriage 10.

The carriage 10, the ink jet head 11, and the ink cartridge 15 are collectively called ink jet head.

In this embodiment, an example of using a single-color ink cartridge 15 and using ink as the liquid is described. Alternatively, the ink cartridge 15 may be arranged at a location other than the carriage 10.

A flushing area 17 of the ink jet head 11 is provided on one side of the platen 2. By ejecting ink from the nozzle holes 13 of the ink jet head 11 to the flushing area 17, ink increased in viscosity is discharged.

A cleaning area 18 including a cap (not illustrated) is provided on one side of the flushing area 17. By ejecting ink to the cleaning area 18 while the cap is attached so as to cover the nozzle rows 14 of the ink jet head 11, the nozzle holes 13 are cleaned.

Two plasma actuators 20 are arranged on the liquid ejection surface 12, which is a surface of the carriage 10 facing the platen 2, on both end portions in a movement direction of the carriage 10 with the nozzle rows 14 interposed therebetween. Each plasma actuator 20 is longer than the nozzle rows 14. The gap between the liquid ejection surface 12 and the printing medium 3 is typically narrow, and may be occasionally 1 mm or less. Hence, as illustrated in FIG. 2, each plasma actuator 20 has to be arranged on a surface recessed by one step from a surface where the nozzle rows 14 are arranged. The recessed surface also corresponds to the liquid ejection surface 12. Alternatively, the plasma actuator 20 may be embedded in the ink jet head 11 and the step may be eliminated, or may be arranged on a surface at a distance larger than the distance between the nozzle rows 14 and the platen 2.

FIG. 4 is a cross-sectional view illustrating a basic structure of the plasma actuator 20. As illustrated in FIG. 4, the plasma actuator 20 includes electrodes 21a and 21b that are two thin-film electrodes, and a dielectric layer 22 interposed between the electrodes 21a and 21b. When an alternating voltage of several kilovolts with frequencies of several kilohertz is applied between the two electrodes 21a and 21b, a plasma discharge 23 occurs in a portion between the upper electrode 21a and the dielectric layer 22. The plasma discharge 23 generates an airflow flowing from the upper electrode 21a toward the lower electrode 21b. By controlling application of the alternating voltage, the plasma actuator 20 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b.

The plasma actuators 20 are arranged to generate airflows between the liquid ejection surface 12 and the printing medium 3. Since the plasma actuators 20 generate the airflows between the liquid ejection surface 12 and the printing medium 3, a vortex generated when ink is ejected from the nozzle rows 14 can be suppressed.

The plasma actuators 20 can be arranged in a desirable manner as long as airflows can be generated between the liquid ejection surface 12 and the printing medium 3.

For example, the plasma actuators 20 may be configured of two plasma actuators 20 arranged so that airflow generation directions of the plasma actuators 20 are opposite to each other. With this configuration, airflows can be generated on one side of the nozzle rows 14, to two directions.

Alternatively, the plasma actuators 20 may be configured of one plasma actuator 20 arranged so that an airflow is generated in one direction. Alternatively, two electrodes 21a may be prepared and arranged such that an electrode 21b is interposed between the electrodes 21a. By simultaneously driving the two electrodes 21a, airflows generated by the two plasma actuators collide with each other at the electrode 21b, and generate airflows in a direction intersecting with the surface where the electrodes are arranged.

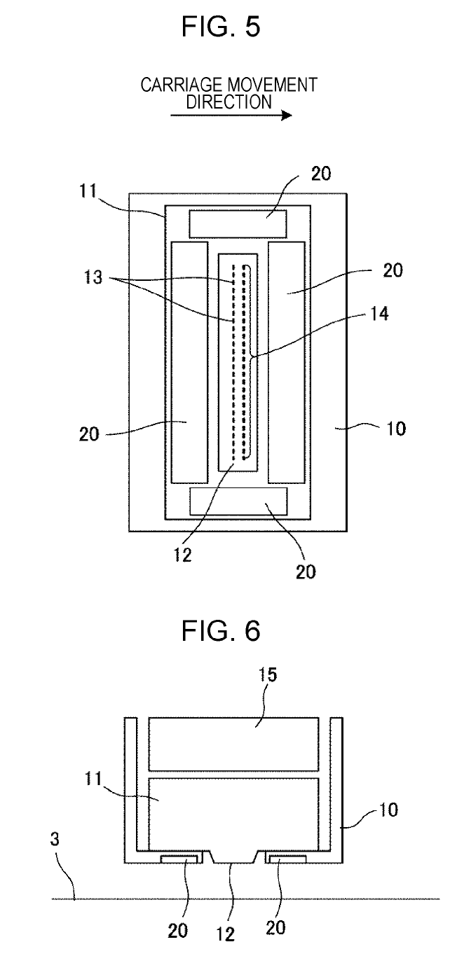

FIG. 5 illustrates a modification in which plasma actuators 20 are arranged also in a direction intersecting with the movement direction of the carriage 10.

With this configuration, airflows can be generated between the liquid ejection surface 12 and the printing medium 3 also in the direction intersecting with the movement direction of the carriage 10.

Alternatively, the plasma actuators 20 may be arranged only in the direction intersecting with the movement direction of the carriage 10.

FIG. 6 illustrates an example in which the plasma actuators 20 are mounted on the carriage 10. As illustrated in FIG. 6, the plasma actuators 20 are mounted on the carriage 10 such that the plasma actuators 20 are embedded in the carriage 10.

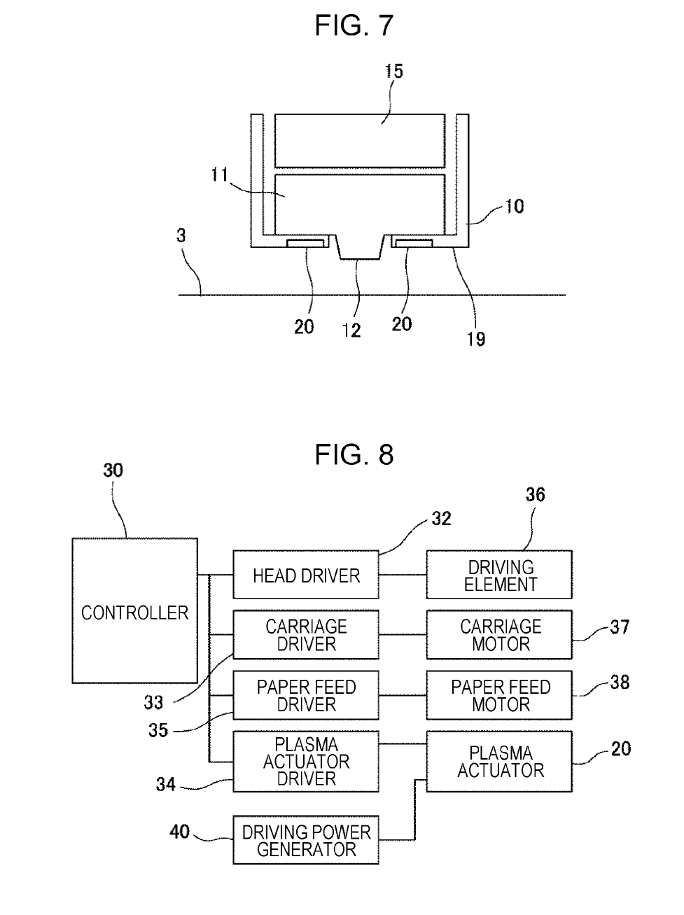

FIG. 7 illustrates a modification of an arrangement structure of the plasma actuators 20. As illustrated in FIG. 7, step surfaces 19 may be formed at the carriage 10 at positions farther from the printing medium 3 than the liquid ejection surface 12 of the ink jet head 11, and the plasma actuators 20 may be arranged on the step surfaces 19.

Even when the plasma actuators 20 are arranged on the ink jet head 11 as illustrated in FIG. 2, step surfaces may be likewise formed at the ink jet head 11.

A control configuration of this embodiment is described next.

FIG. 8 is a block diagram illustrating a functional configuration of the printer 1 according to this embodiment.

As illustrated in FIG. 8, the printer 1 includes a controller 30 that controls respective devices, and various driver circuits that drive various motors and so forth under the control of the controller 30 and output a detection state of a detection circuit to the controller 30. The various driver circuits include a head driver 32, a carriage driver 33, a plasma actuator driver 34, and a paper feed driver 35.

The controller 30 centrally controls the respective devices of the printer 1. The controller 30 includes, for example, a CPU, a ROM that stores an executable basic control program and data relating to the basic control program in a non-volatile manner, a RAM that temporarily stores a program to be executed by the CPU and predetermined data, and other peripheral circuits.

The head driver 32 is coupled to a driving element 36 such as a piezoelectric element for ejecting ink. The driving element 36 is driven under the control of the controller 30, and causes ink to be ejected from the nozzle hole 13 by a required amount.

The carriage driver 33 is coupled to a carriage motor 37, and outputs a driving signal to the carriage motor 37 to operate the carriage motor 37 in a range instructed by the controller 30.

The plasma actuator driver 34 is coupled to each plasma actuator 20, and outputs a driving signal to the plasma actuator 20 to drive the plasma actuator 20 through the controller 30.

The paper feed driver 35 is coupled to a paper feed motor 38, and outputs a driving signal to the paper feed motor 38 to operate the paper feed motor 38 by an amount instructed by the controller 30. The printing medium 3 is transported in the transport direction by a predetermined amount in accordance with the operation of the paper feed motor 38.

To drive each plasma actuator 20, a high voltage is required. The printer 1 includes a driving voltage generator 40 that generates a driving voltage for driving the plasma actuator 20. The driving voltage generator 40 is coupled to the plasma actuator 20. Alternatively, the driving voltage generator 40 may be coupled to the plasma actuator driver 34.

With a serial printer, a flexible cable that transmits a head driving signal is arranged on the movable carriage 10. It is not desirable to additionally arrange high-voltage wiring for driving the plasma actuator 20 in the flexible cable because a problem may arise in distance for insulation, countermeasure for short-circuit, and countermeasure for noise.

Owing to this, in this embodiment, a low-voltage power supply line is arranged in the flexible cable, and the driving voltage generator 40 is mounted on the ink jet head 11 or the carriage 10. The driving voltage generator 40 uses the low-voltage power as an input voltage, and raises the input voltage to a high voltage.

When a piezoelectric element is used for the driving element 36, since the power supply line for driving the piezoelectric element is arranged in the flexible cable, a power for driving the piezoelectric element may be used as an input voltage to the driving voltage generator 40. Also when a thermal-type driving element is used for the driving element 36, a power for driving the thermal head may be used as an input voltage to the driving voltage generator 40 likewise. Of course, an independent low-voltage power line may be arranged in the flexible cable.

Note that, unless a problem arises in distance for insulation, countermeasure for short-circuit, and countermeasure for noise, high-voltage wiring for driving the plasma actuator 20 may be arranged in the flexible cable, or another cable for high-voltage wiring different from the flexible cable for transmitting the head driving signal may be arranged.

The controller 30 controls driving of the plasma actuator 20 via the plasma actuator driver 34.

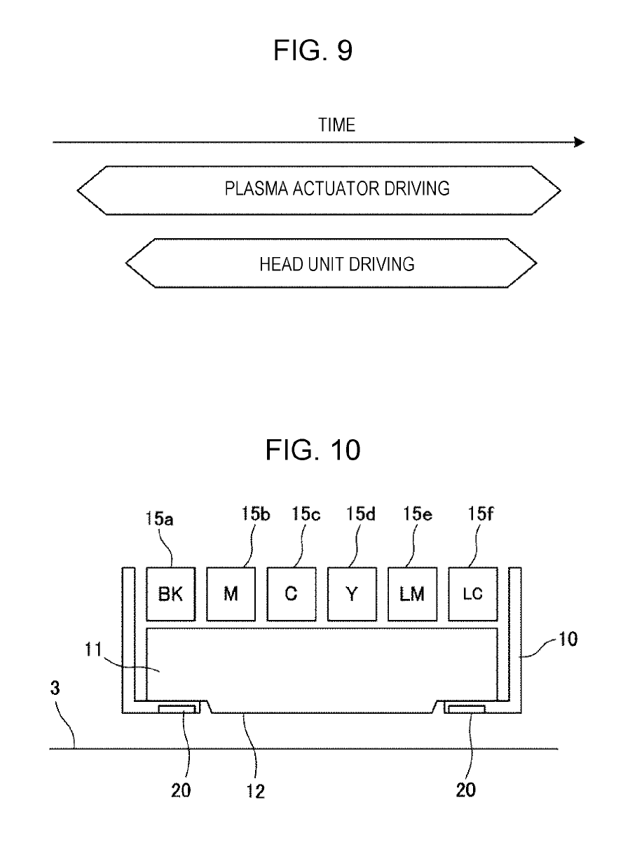

FIG. 9 is a timing chart illustrating a driving timing of the plasma actuator 20 with respect to a printing timing of the ink jet head 11.

As illustrated in FIG. 9, for example, in comparison to a timing at which the driving element 36 of the ink jet head 11 is driven and ink is ejected, the controller 30 performs control to start the driving of the plasma actuator 20 earlier than the ejection start of ink. Also, the controller 30 performs control to end the driving of the plasma actuator 20 later than the ejection end of ink.

By driving the plasma actuator 20 for a period longer than the ejection time of ink as described above, a vortex generated by ejection of ink can be suppressed.

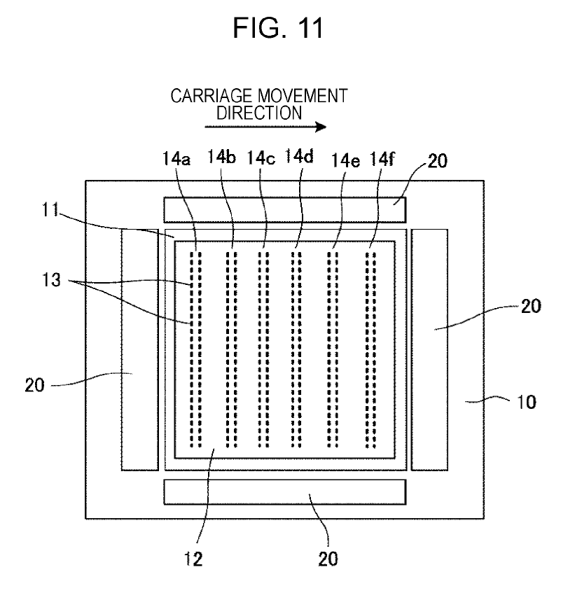

While the ink jet head 11 with single-color ink is used according to this embodiment, the invention is not limited thereto. For example, an ink jet head 11 illustrated in FIGS. 10 and 11 may be used.

FIG. 10 illustrates a case where a plurality of colors of nozzle rows 14 and ink tanks are mounted for full-color printing. FIG. 11 is an illustration when viewed from the liquid ejection surface in FIG. 10.

That is, as illustrated in FIGS. 10 and 11, a plurality of colors (in this case, six colors) of nozzle rows 14a, 14b, 14c, 14d, 14e, and 14f are formed in the liquid ejection surface 12 of the ink jet head 11 mounted on the carriage 10. Ink cartridges 15a, 15b, 15c, 15d, 15e, and 15f that supply the ink jet head 11 with the respective colors of ink are mounted on the carriage 10. The ink cartridges 15a, 15b, 15c, 15d, 15e, and 15f store the respective colors of ink of black (BK), magenta (M), cyan (C), yellow (Y), light magenta (LM), and light cyan (LC).

The plasma actuators 20 are arranged on both end portions in the movement direction of the carriage 10. Also, the plasma actuators 20 are also arranged in the direction intersecting with the movement direction of the carriage 10 of the plasma actuators 20.

By arranging the plasma actuators 20 as described above, even when full-color printing is performed, a vortex generated by ejection of ink can be suppressed.

In this case, plasma actuators 20 may be arranged between the nozzle rows 14 of the respective colors.

While the plasma actuators 20 are arranged on the liquid ejection surface 12 of the ink jet head 11 or the carriage 10 according to the above-described embodiment, the invention is not limited thereto. For example, if a separate moving member that moves in synchronization with the carriage 10 is provided, the plasma actuators 20 may be arranged on this moving member.

Alternatively, the plasma actuators 20 may be formed as a unit, and the unit may be arranged in a manner attachable to and detachable from the ink jet head 11, the carriage 10, or the moving member.

Further, although not illustrated, the plasma actuator may be configured of a plurality of plasma actuators. In this case, there may be a nozzle hole that ejects ink and a nozzle hole that does not eject ink. In such a case, only a plasma actuator corresponding to the nozzle hole that ejects ink may be driven.

The ink jet head may be configured such that a plurality of unit ink jet heads are arranged in a staggered manner, and plasma actuators are arranged individually for the unit ink jet heads. In this case, among the unit ink jet heads, a unit ink jet head that ejects ink from the nozzle rows 14 and a unit ink jet head that does not eject ink from the nozzle rows 14 may be present. In such a case, only a plasma actuator corresponding to the unit ink jet head that ejects ink may be driven.

A printing method of this embodiment is described next.

When printing is performed, the controller 30 performs control on the head driver 32, the carriage driver 33, and the paper feed driver 35. Thus, by driving the driving element 36 while driving the carriage motor 37 to reciprocate the carriage 10, ink is ejected from the nozzle holes 13, and thus printing is performed on the printing medium 3.

After the printing is performed on the printing medium 3 through the reciprocation of the carriage 10, the paper feed motor 38 is driven to transport the printing medium 3 by a predetermined amount in the transport direction. Then, the printing is performed on the printing medium 3 again while the carriage 10 is moved.

In this case, the controller 30 outputs a driving signal to each plasma actuator 20, and causes the plasma actuator 20 to be driven.

Thus, by driving the plasma actuator 20 and generating an airflow between the liquid ejection surface 12 and the printing medium 3, a vortex generated when ink is ejected from the nozzle rows 14 can be suppressed.

As described above, in the embodiment to which the invention is applied, the ink jet head 11 is provided that ejects liquid from the nozzle rows 14 being open in the liquid ejection surface 12 arranged on the surface facing the printing medium 3. Also, the plasma actuator 20, and the controller 30 that controls the ink jet head 11 and the plasma actuator 20 are provided. When the nozzle rows 14 eject liquid to the printing medium 3, the controller 30 drives the plasma actuator 20 to generate an airflow between the liquid ejection surface 12 and the printing medium 3.

Thus, by driving the plasma actuator 20 and generating the airflow between the liquid ejection surface 12 and the printing medium 3, a vortex generated when ink is ejected from the nozzle rows 14 can be suppressed. Consequently, generation of a wind ripple on the printing medium 3 can be reduced, and printing quality can be improved.

In an example of this embodiment, the ink jet head 11 may be a serial-type ink jet head 11 mounted on the carriage 10 that reciprocates in a main-scanning direction.

Accordingly, with the serial-type ink jet head 11 mounted on the carriage 10 that reciprocates in the main-scanning direction, a vortex generated when ink is ejected from the nozzle rows 14 can be suppressed.

In an example of this embodiment, the plasma actuators 20 may be arranged beside the nozzle rows 14 in the movement direction of the ink jet head 11.

Thus, with the plasma actuators 20, airflows can be generated between the liquid ejection surface 12 and the printing medium 3 on both sides of the nozzle rows 14, and hence a vortex generated when ink is ejected from the nozzle rows 14 can be suppressed.

In an example of this embodiment, the plasma actuators 20 may be arranged beside the nozzle rows 14 in the direction intersecting with the movement direction of the ink jet head 11.

Thus, with the plasma actuators 20, airflows can be generated between the liquid ejection surface 12 and the printing medium 3 on both ends of the nozzle rows 14, and hence a vortex generated when ink is ejected from the nozzle rows 14 can be suppressed.

In an example of this embodiment, each plasma actuator 20 may be arranged at a position separated by a distance larger than the distance between the liquid ejection surface 12 and a recording surface of the printing medium 3.

Accordingly, an airflow can be generated between the liquid ejection surface 12 and the printing medium 3 at the position separated from the liquid ejection surface 12, and hence a vortex generated when ink is ejected from the nozzle rows 14 can be suppressed.

In an example of this embodiment, each plasma actuator 20 may be attachable and detachable.

Accordingly, the plasma actuator 20 can be easily exchanged when the plasma actuator 20 is contaminated or broken.

In an example of this embodiment, the driving voltage generator 40 that generates a driving voltage for driving each plasma actuator 20 is further provided. The driving voltage generator 40 may be mounted on the ink jet head 11.

Accordingly, the driving voltage for the plasma actuator 20 that is driven with a high voltage can be generated by the driving voltage generator 40. Thus, high voltage wiring is not required to be arranged in the flexible cable provided on the carriage 10, and a problem does not arise in insulation, countermeasure for short-circuit, and countermeasure for noise.

In an example of this embodiment, wiring for supplying an ink jet driving voltage for driving the ink jet head 11 may be provided. Also, the driving voltage generator 40 may generate a voltage for driving each plasma actuator 20 by using the ink jet driving voltage supplied via the wiring.

Accordingly, since the voltage for driving the plasma actuator 20 is generated by using the wiring that supplies the ink jet driving voltage, a power source dedicated for the plasma actuator 20 is not required.

### Second Embodiment

A second embodiment of the invention is described next.

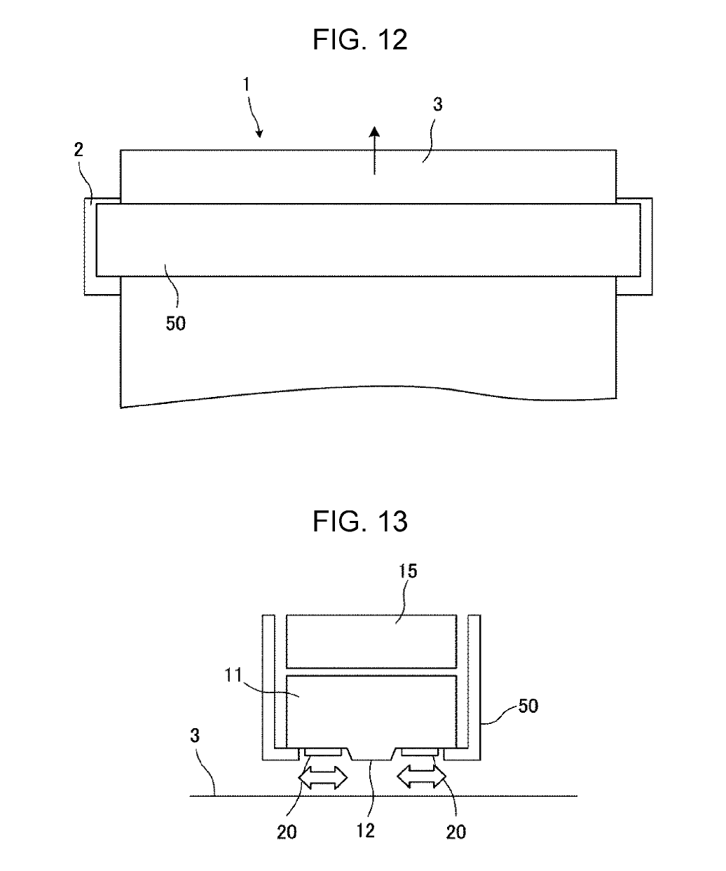

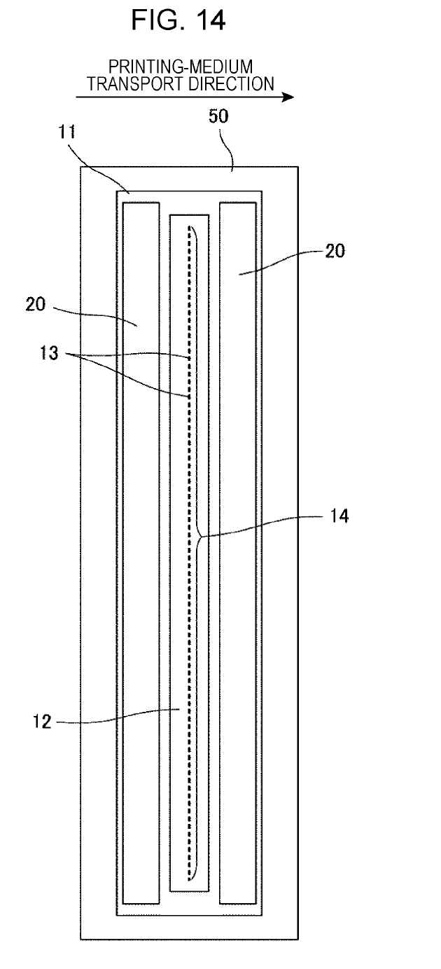

FIG. 12 is a schematic illustration of a printer according to the second embodiment. FIG. 13 is a schematic illustration of an ink jet head of the printer according to the second embodiment. FIG. 14 is a schematic illustration when viewed from a liquid ejection surface in FIG. 13. In the second embodiment, a case of using a line-type ink jet head extending in a direction intersecting with a transport direction of a printing medium is described.

Note that the same reference sings are applied to the same portions as those of the first embodiment, and the description thereof is omitted.

As illustrated in FIG. 12, a printer 1 includes a flat-plate-shaped platen 2. A predetermined printing medium 3 is transported on an upper surface of the platen 2 in a sub-scanning direction by a paper feed motor 38 serving as a printing-medium transport portion.

A support member 50 that extends in a direction intersecting with a transport direction of the printing medium 3 is provided above the platen 2. The support member 50 includes a linear ink jet head 11. The platen 2 may be provided with an ink discarding region for no-margin printing.

A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject liquid, for example, ink on the printing medium 3.

The ink jet head 11 includes a driving element 36 such as a piezoelectric element for ejecting liquid from each of the nozzle holes 13. Also, an ink cartridge 15 that supplies the ink jet head 11 with ink is mounted on the support member 50.

The ink jet head 11, the ink cartridge 15, and the support member 50 are collectively called line-type ink jet head.

In this embodiment, an example of using a single-color ink cartridge 15 and using ink as the liquid is described. Alternatively, the ink cartridge 15 may be arranged at a location other than the support member 50.

Two plasma actuators 20 are arranged on a surface of the liquid ejection surface 12 of the ink jet head 11 facing the platen 2, on both end portions in the transport direction of the printing medium 3 of a printing medium with the nozzle row 14 interposed therebetween. Each plasma actuator 20 is longer than the nozzle row 14.

The plasma actuators 20 are arranged to generate airflows between the liquid ejection surface 12 and the printing medium 3. Since the plasma actuators 20 generate the airflows between the liquid ejection surface 12 and the printing medium 3, a vortex generated when ink is ejected from the nozzle row 14 can be suppressed.

The plasma actuators 20 can be arranged in a desirable manner as long as airflows can be generated between the liquid ejection surface 12 and the printing medium 3.

For example, the plasma actuators 20 may be configured of two plasma actuators 20 arranged so that airflow generation directions of the plasma actuators 20 are opposite to each other. With this configuration, airflows can be generated on one side of the nozzle rows 14, to two directions.

Alternatively, the plasma actuators 20 may be configured of one plasma actuator 20 arranged so that an airflow is generated in one direction.

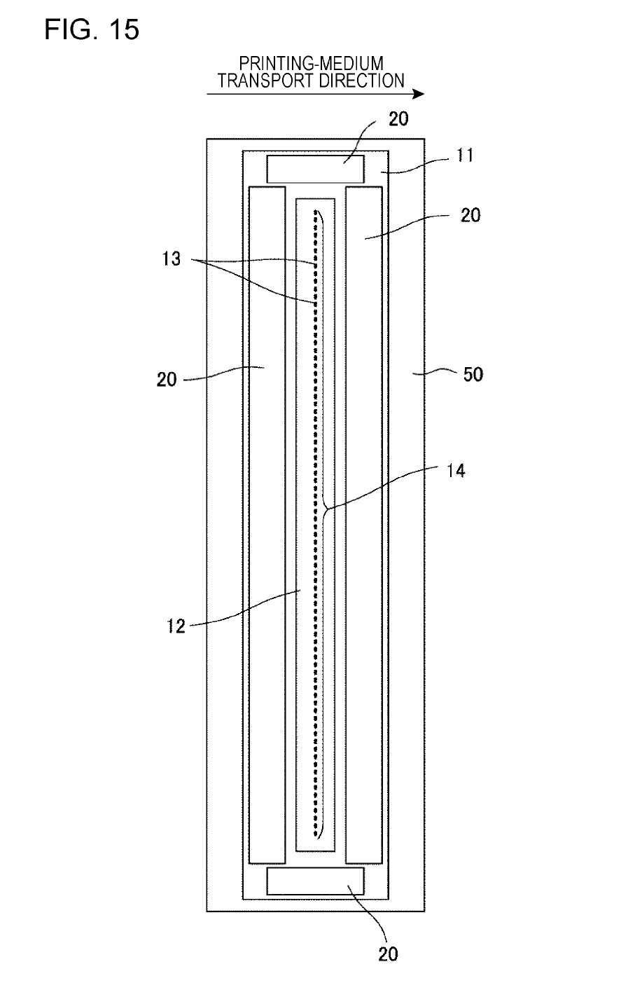

FIG. 15 illustrates a modification in which plasma actuators 20 are arranged also in a direction intersecting with the transport direction of the printing medium 3.

With this configuration, airflows can be generated between the liquid ejection surface 12 and the printing medium 3 also in the direction intersecting with the transport direction of the printing medium 3.

Alternatively, the plasma actuators 20 may be arranged only in the direction intersecting with the transport direction of the printing medium 3.

Although not illustrated, similarly to the second embodiment, plasma actuators 20 according to a modification may be mounted on the support member 50. Step surfaces may be formed at positions farther from the printing medium 3 than the liquid ejection surface 12 of the ink jet head 11, and the plasma actuators 20 may be arranged on the step surfaces. The gap between the liquid ejection surface 12 and the printing medium 3 is typically narrow, and may be occasionally 1 mm or less. Hence, as illustrated in FIG. 13, each plasma actuator 20 has to be arranged on a surface recessed by one step from a surface where the nozzle rows 14 are arranged. The recessed surface also corresponds to the liquid ejection surface 12. Alternatively, the plasma actuator 20 may be embedded in the ink jet head 11 and the step may be eliminated, or may be arranged on a surface at a distance larger than the distance between the nozzle row 14 and the platen 2.

While the plasma actuators 20 are arranged on the single ink jet head 11 according to this embodiment, the invention is not limited thereto.

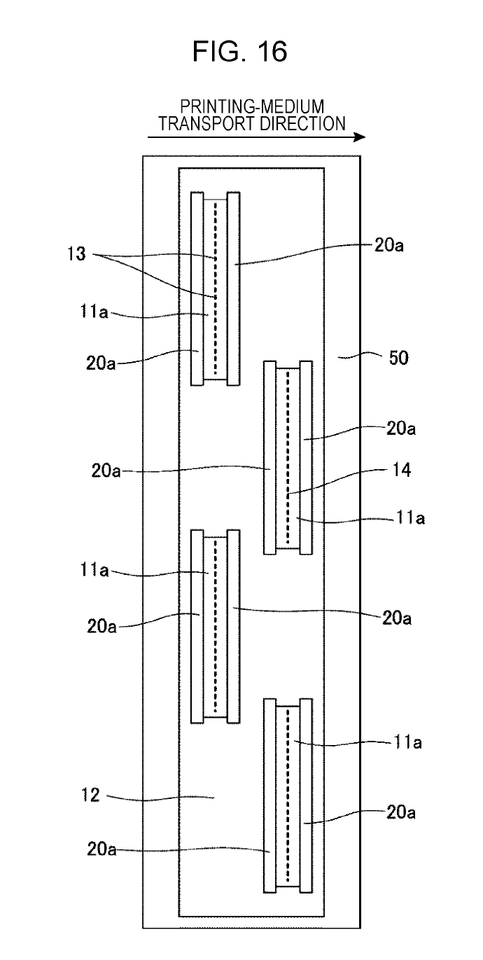

FIG. 16 illustrates an example in which the ink jet head 11 is configured of a plurality of unit ink jet heads 11a. As illustrated in FIG. 16, the unit ink jet heads 11a may be arranged in a staggered manner, and plasma actuators 20a may be arranged individually for the unit ink jet heads 11a.

In this case, among the unit ink jet heads 11a, a unit ink jet head 11a that ejects ink from the nozzle row 14 and a unit ink jet head 11a that does not eject ink from the nozzle row 14 may be present. In this case, only a plasma actuator 20a corresponding to the unit ink jet head 11a that ejects ink may be driven. Alternatively, the plasma actuators 20 may not be arranged individually for the unit ink jet heads 11a.

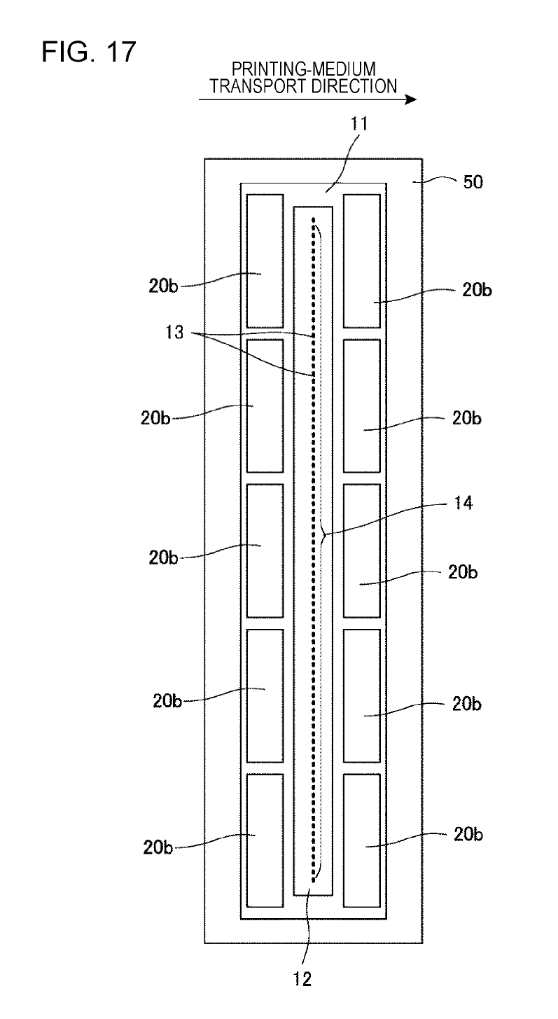

FIG. 17 illustrates an example in which each plasma actuator 20 is configured of a plurality of plasma actuators 20b arranged in line. As illustrated in FIG. 17, even when the plurality of plasma actuators 20b are arranged in line, similar advantages can be attained.

Also, in this case, in the ink jet head 11, the nozzle row 14 may include a nozzle hole 13 that ejects ink and a nozzle hole 13 that does not eject ink. In such a case, only a plasma actuator 20b corresponding to the nozzle hole 13 that ejects ink may be driven.

Also, the plasma actuators 20 may be formed as a unit, and the unit may be arranged in a manner attachable to and detachable from the ink jet head 11 or the support member 50.

A printing method of this embodiment is described next.

When the printer 1 performs printing, the controller 30 performs control on the head driver 32 and the paper feed driver 35. Accordingly, by driving the driving element 36 while driving the paper feed motor 38 to transport the printing medium 3 in the transport direction, ink is ejected from the nozzle holes 13, and thus printing is performed on the printing medium 3.

In this case, according to this embodiment, the controller 30 outputs a driving signal to each plasma actuator 20, and causes the plasma actuator 20 to be driven.

Thus, by driving the plasma actuator 20 and generating an airflow between the liquid ejection surface 12 and the printing medium 3, a vortex generated when ink is ejected from the nozzle row 14 can be suppressed.

Alternatively, the printer 1 according to this embodiment may include a plurality of ink jet heads 11 for performing color printing. In this case, by applying the above-described configuration to each ink jet head 11, a vortex generated when ink is ejected from the nozzle row 14 can be suppressed.

As described above, in the embodiment to which the invention is applied, the ink jet head 11 is a line-type ink jet head 11 extending in the direction intersecting with the transport direction of the printing medium 3.

Thus, by driving the plasma actuator 20 and generating an airflow between the liquid ejection surface 12 and the printing medium 3, a vortex generated when ink is ejected from the nozzle row 14 can be suppressed. Consequently, generation of a wind ripple on the printing medium 3 can be reduced, and printing quality can be improved.

In an example of this embodiment, the plasma actuators 20 may be arranged beside the nozzle row 14 in the transport direction of the printing medium 3.

Thus, with the plasma actuators 20, airflows can be generated between the liquid ejection surface 12 and the printing medium 3 on both sides of the line-type nozzle row 14, and hence a vortex generated when ink is ejected from the nozzle row 14 can be suppressed.

In an example of this embodiment, the plasma actuators 20 may be configured of a plurality of plasma actuators 20.

Accordingly, since the plurality of plasma actuators 20 are arranged, only a plasma actuator 20 corresponding to the nozzle hole that ejects ink can be individually driven.

In an example of this embodiment, the ink jet head 11 is configured such that a plurality of unit ink jet heads are arranged in a staggered manner, and the plasma actuators 20 are arranged individually for the unit ink jet heads.

Accordingly, the plasma actuators 20 can be driven on the unit ink jet head basis, and hence the plasma actuator 20 can be driven in accordance with the ejection operation of ink by the unit ink jet head.

### Third Embodiment

A third embodiment of the invention is described next.

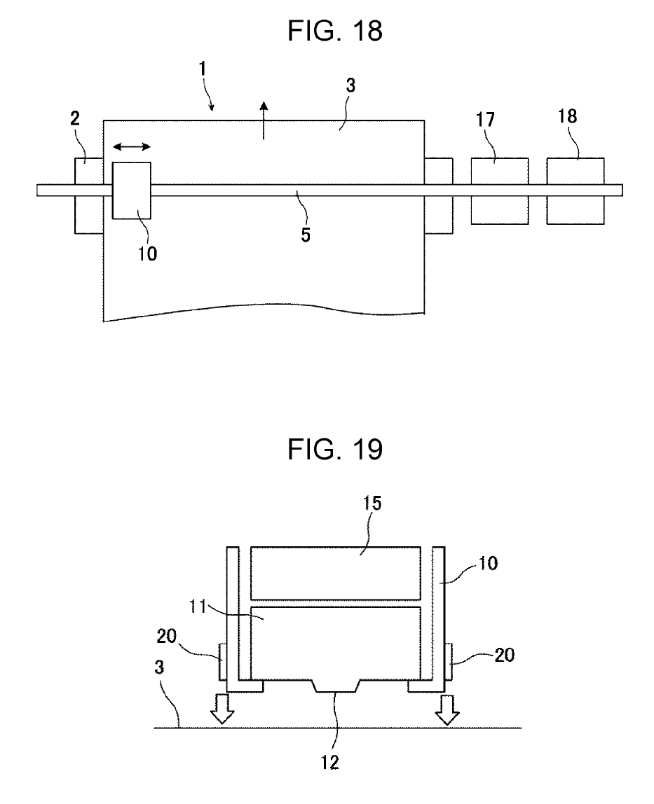

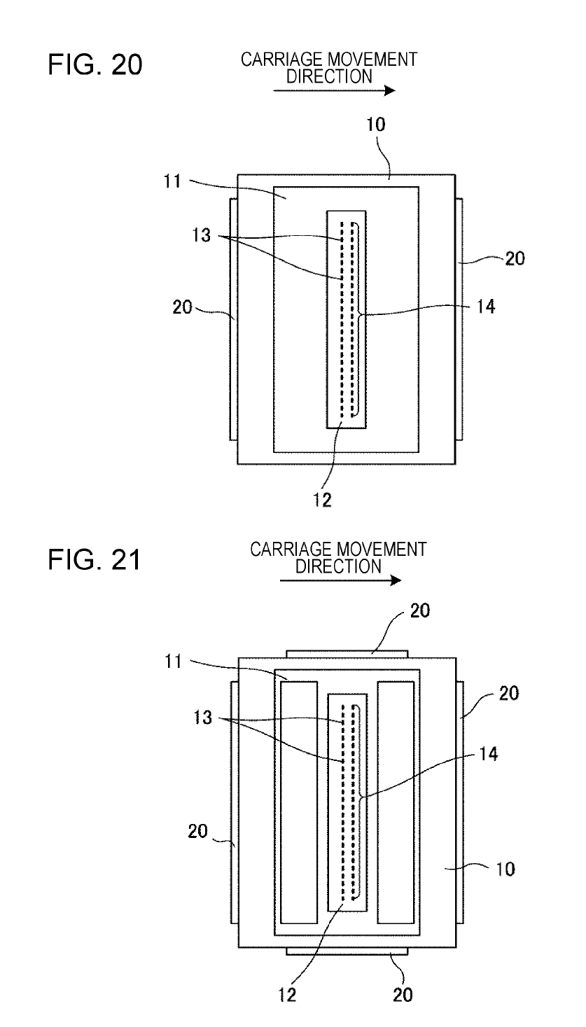

FIG. 18 is a schematic illustration of a printer according to the third embodiment. FIG. 19 is a schematic illustration of an ink jet head of the printer according to the third embodiment. FIG. 20 is a schematic illustration when viewed from a liquid ejection surface in FIG. 19. Described in the third embodiment is a case where a serial-type ink jet head mounted on a carriage that reciprocates in a main-scanning direction is used as an ink jet head.

Note that the same reference sings are applied to the same portions as those of any of the above-described embodiments, and the description thereof is omitted.

As illustrated in FIG. 18, a printer 1 includes a flat-plate-shaped platen 2. A predetermined printing medium 3 is transported on an upper surface of the platen 2 in a sub-scanning direction by a paper feed mechanism (not illustrated). The platen 2 may be provided with an ink discarding region for no-margin printing.

The printing medium 3 is similar to that of any of the above-described embodiments.

A guide shaft 5 that extends in a direction orthogonal to a transport direction of the printing medium 3 is provided above the platen 2. A carriage 10 is provided on the guide shaft 5 so that the carriage 10 can be driven to reciprocate along the guide shaft 5 via a driving mechanism (not illustrated).

As illustrated in FIGS. 19 and 20, an ink jet head 11 is mounted on the carriage 10. A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject liquid, for example, ink on the printing medium 3. In this embodiment, the nozzle row 14 includes two nozzle rows 14 formed in parallel to each other.

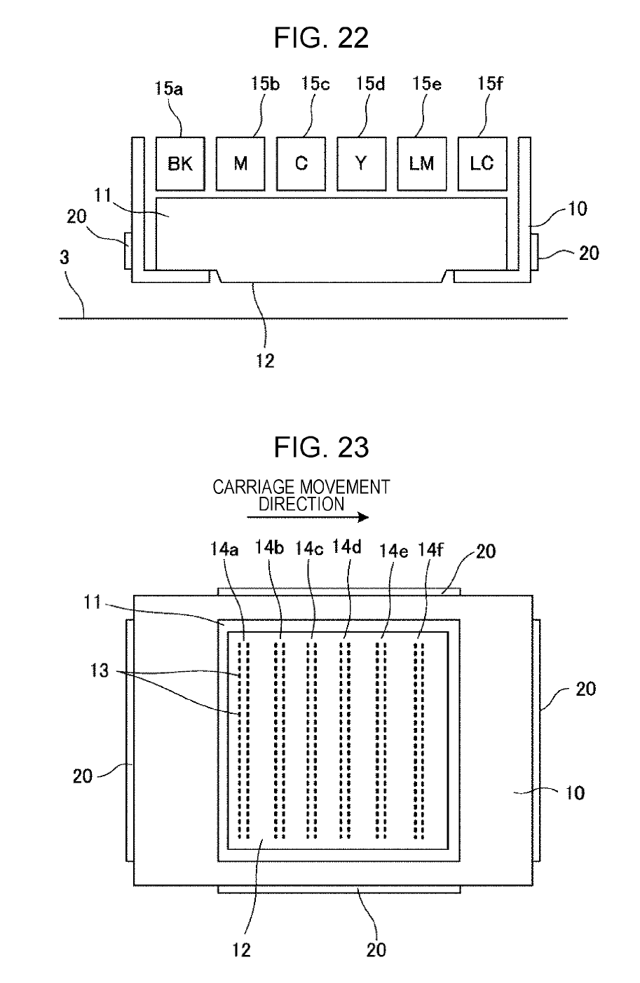

The ink jet head 11 includes a driving element 36 (see FIG. 22) such as a piezoelectric element for ejecting liquid from each of the nozzle holes 13. Also, an ink cartridge 15 that supplies the ink jet head 11 with ink is mounted on the carriage 10.

The carriage 10, the ink jet head 11, and the ink cartridge 15 are collectively called ink jet head.

In this embodiment, an example of using a single-color ink cartridge 15 and using ink as the liquid is described. Alternatively, the ink cartridge 15 may be arranged at a location other than the carriage 10.

Similarly to any of the above-described embodiments, a flushing area 17 of the ink jet head 11 is provided on one side of the platen 2. A cleaning area 18 including a cap (not illustrated) is provided on one side of the flushing area 17.

The carriage 10 has four side surfaces intersecting with the liquid ejection surface 12. Two plasma actuators 20 are arranged on both side surfaces in a movement direction of the carriage 10. Each plasma actuator 20 is longer than the nozzle rows 14.

In this embodiment, each plasma actuator 20 is arranged at a position separated by a distance larger than the distance between the liquid ejection surface 12 of the nozzle rows 14 and a recording surface of the printing medium 3.

The basic structure of each plasma actuator 20 is similar to the above-described embodiment illustrated in FIG. 4. Hence, by adjusting the arrangement of two electrodes 21a and 21b, an airflow can be generated in a desirable direction. Also, by controlling application of the alternating voltage, the plasma actuator 20 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b.

The plasma actuators 20 are arranged to generate airflows toward the printing medium 3. Since the plasma actuators 20 generate the airflows toward the printing medium 3, an air curtain can be formed around the nozzle rows 14 when the nozzle rows 14 perform ejection.

The plasma actuators 20 may be arranged in a desirable manner as long as the plasma actuators 20 can generate airflows toward the printing medium 3. For example, two electrodes 21a may be prepared and arranged such that an electrode 21b is interposed between the electrodes 21a. By simultaneously driving the two electrodes 21a, airflows generated by the two plasma actuators 20 collide with each other at the electrode 21b, and generate airflows in a direction intersecting with the surface where the electrodes are arranged.

FIG. 21 illustrates a modification in which plasma actuators 20 are arranged also in a direction intersecting with the movement direction of the carriage 10.

With this configuration, airflows can be generated toward the printing medium 3 also in the direction intersecting with the movement direction of the carriage 10.

Alternatively, the plasma actuators 20 may be arranged only in the direction intersecting with the movement direction of the carriage 10.

The control configuration of this embodiment and the driving timings of the plasma actuators 20 are similar to the control configuration (see FIG. 8) of the above-described embodiment and the driving timings (see FIG. 9), and therefore the description is omitted.

Also in this embodiment, by driving the plasma actuators 20 for a period longer than the ejection time of ink as illustrated in the timing chart in FIG. 9, an air curtain can be formed around the nozzle rows 14 from a time point before ejection of ink to a time point after the end of ejection.

While the ink jet head 11 with single-color ink is used according to this embodiment, the invention is not limited thereto. For example, an ink jet head 11 illustrated in FIGS. 22 and 23 may be used.

FIG. 22 schematically illustrates the ink jet head 11 on which a plurality of colors of nozzle rows 14 and ink tanks are mounted for full-color printing. FIG. 23 is an illustration when viewed from the liquid ejection surface in FIG. 22.

That is, as illustrated in FIGS. 22 and 23, a plurality of colors (in this case, six colors) of nozzle rows 14a, 14b, 14c, 14d, 14e, and 14f are formed in the liquid ejection surface 12 of the ink jet head 11 mounted on the carriage 10. Ink cartridges 15a, 15b, 15c, 15d, 15e, and 15f that supply the ink jet head 11 with the respective colors of ink are mounted on the carriage 10. The ink cartridges 15a, 15b, 15c, 15d, 15e, and 15f store the respective colors of ink of black (BK), magenta (M), cyan (C), yellow (Y), light magenta (LM), and light cyan (LC).

The plasma actuators 20 are arranged on both side portions of side surfaces in the movement direction of the carriage 10. Also, the plasma actuators 20 are arranged on side surfaces in a direction intersecting with the movement direction of the carriage 10.

By arranging the plasma actuators 20 in this way, even with the ink jet head that performs full-color printing, an air curtain can be formed around the nozzle rows 14 when the nozzle rows 14 eject ink.

In this case, plasma actuators 20 may be arranged between the nozzle rows 14 of the respective colors.

While the plasma actuators 20 are arranged on the liquid ejection surface 12 of the ink jet head 11 or the carriage 10 according to the above-described embodiment, the invention is not limited thereto. For example, if a separate moving member that moves in synchronization with the carriage 10 is provided, the plasma actuators 20 may be arranged on this moving member.

Alternatively, the plasma actuators 20 may be formed as a unit, and the unit may be arranged in a manner attachable to and detachable from the ink jet head 11, the carriage 10, or the moving member.

Further, although not illustrated, the plasma actuators may be configured of a plurality of plasma actuators. In this case, there may be a nozzle hole that ejects ink and a nozzle hole that does not eject ink. In such a case, only a plasma actuator corresponding to the nozzle hole that ejects ink may be driven.

The ink jet head may be configured such that a plurality of unit ink jet heads are arranged in a staggered manner, and plasma actuators are arranged individually for the unit ink jet heads. In this case, among the unit ink jet heads, a unit ink jet head that ejects ink from the nozzle rows 14 and a unit ink jet head that does not eject ink from the nozzle rows 14 may be present. In such a case, only a plasma actuator corresponding to the unit ink jet head that ejects ink may be driven.

The printing method of this embodiment is similar to the printing method of any of the above-described embodiments and hence the description is omitted.

With the printing method of this embodiment, since the plasma actuators 20 are driven to generate the airflows toward the printing medium 3, an air curtain can be formed around the nozzle rows 14 when the nozzle rows 14 perform ejection. By forming the air curtain in this way, the movement of the air with the movement of the carriage 10 can be suppressed.

As described above, in the embodiment to which the invention is applied, the ink jet head 11 that ejects liquid from the nozzle rows 14 on the printing medium 3, and the plasma actuators 20 are provided. Also, a controller 30 that controls the ink jet head 11 and the plasma actuators 20 are provided. When the nozzle rows 14 eject liquid, the controller 30 drives the plasma actuators 20 to generate airflows in a direction from the ink jet head 11 toward the printing medium 3.

Accordingly, by driving the plasma actuators 20 to generate the airflows toward the printing medium 3, an air curtain can be formed, and a turbulence generated due to the movement of the air with the movement of the carriage 10 can be suppressed. Consequently, deviation of an ink-landing position can be reduced, and printing quality can be improved.

In an example of this embodiment, the ink jet head 11 may be a serial-type ink jet head 11 that reciprocates in a main-scanning direction.

Accordingly, with the serial-type ink jet head 11 mounted on the carriage 10 that reciprocates in the main-scanning direction, the air curtain is formed by generating the airflows toward the printing medium 3, and hence a turbulence generated due to the movement of the air between the ink jet head 11 and the printing medium 3 can be suppressed.

In an example of this embodiment, the ink jet head 11 has the liquid ejection surface 12 in which the nozzle rows 14 are open and which face the printing medium 3, and the side surfaces intersecting with the liquid ejection surface 12. The plasma actuators 20 may be arranged on the side surfaces in the movement direction of the ink jet head 11.

Accordingly, the plasma actuators 20 arranged on the side surfaces in the movement direction of the ink jet head 11 can generate airflows toward the printing medium 3, and an air curtain can be formed at the side surfaces in the movement direction of the ink jet head 11.

In an example of this embodiment, the plasma actuators 20 may be arranged on the side surfaces intersecting with the movement direction of the carriage 10 (the ink jet head 11).

Accordingly, the plasma actuators 20 arranged on the side surfaces intersecting with the movement direction of the ink jet head 11 can generate airflows toward the printing medium 3, and an air curtain can be formed at the side surfaces intersecting with the movement direction of the ink jet head 11.

In an example of this embodiment, each plasma actuator 20 may be arranged at a position separated by a distance larger than the distance between the liquid ejection surface 12 of the nozzle rows 14 and a recording surface of the printing medium 3.

Accordingly, an airflow toward the printing medium 3 can be generated at a position separated from the liquid ejection surface 12, and an air curtain can be formed.

In an example of this embodiment, each plasma actuator 20 may be attachable and detachable.

Accordingly, the plasma actuator 20 can be easily exchanged when the plasma actuator 20 is contaminated or broken.

In an example of this embodiment, a driving voltage generator 40 that generates a driving voltage for driving each plasma actuator 20 is further provided. The driving voltage generator 40 may be mounted on the ink jet head 16.

Accordingly, the driving voltage for the plasma actuator 20 that is driven with a high voltage can be generated by the driving voltage generator 40. Thus, high voltage wiring is not required to be arranged in the flexible cable, and a problem does not arise in insulation, countermeasure for short-circuit, and countermeasure for noise.

In an example of this embodiment, the ink jet head 16 includes wiring for supplying an ink jet driving voltage for driving the ink jet head 11. Also, the driving voltage generator 40 may generate a voltage for driving each plasma actuator 20 by using the ink jet driving voltage supplied via the wiring.

Accordingly, since the voltage for driving the plasma actuator 20 is generated by using the ink jet driving voltage supplied from the wiring, wiring dedicated for the plasma actuator 20 is not required to be arranged.

In an example of this embodiment, the plasma actuator 20 may be arranged on the ink jet head 11.

Accordingly, an airflow toward the printing medium 3 can be generated near the nozzle rows 14, and hence the effect of the air curtain can be further increased.

### Fourth Embodiment

A forth embodiment of the invention is described next.

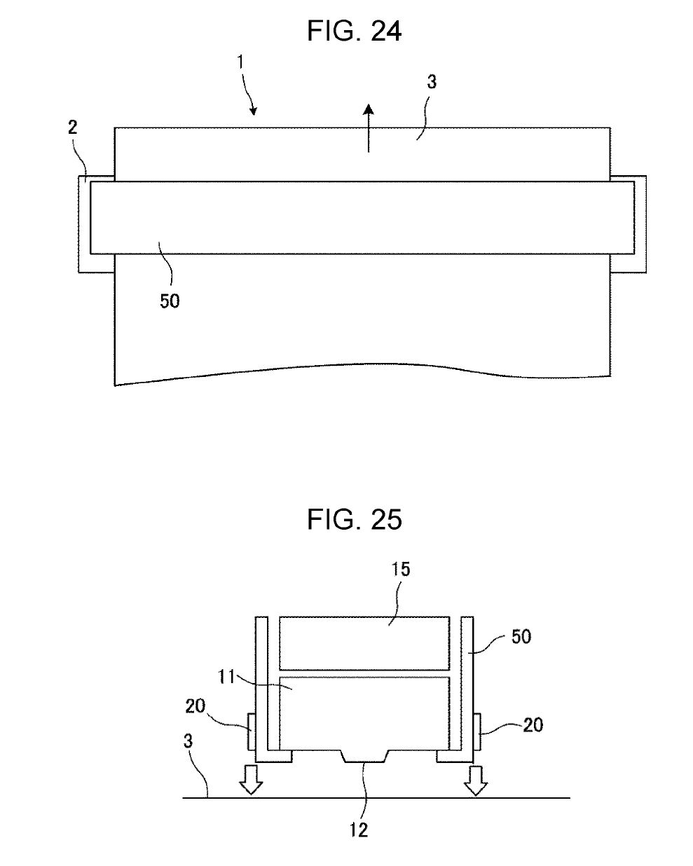

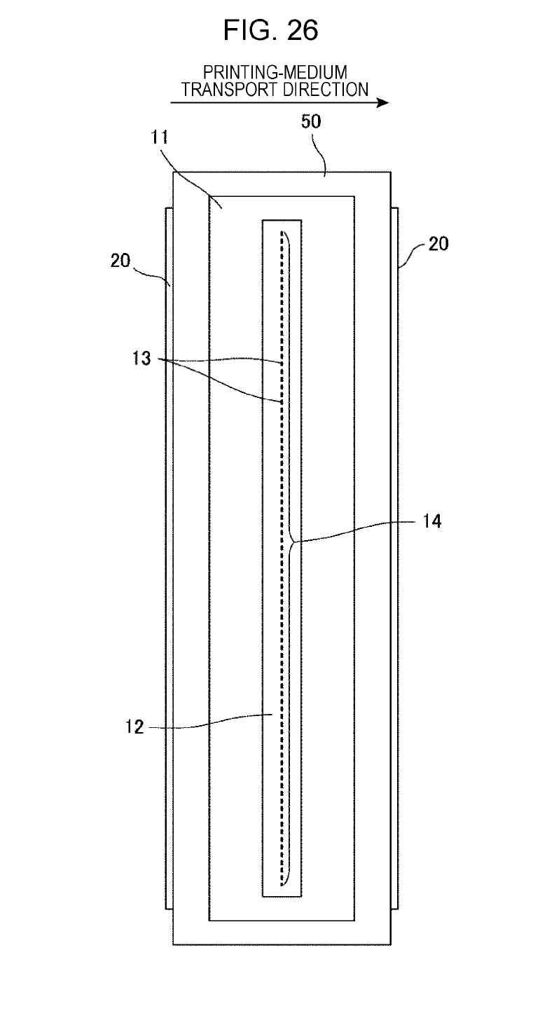

FIG. 24 is a schematic illustration of a printer according to the fourth embodiment. FIG. 25 is a schematic illustration of an ink jet head of the printer according to the fourth embodiment. FIG. 26 is a schematic illustration when viewed from a liquid ejection surface in FIG. 25. In the fourth embodiment, for an ink jet head, a case of using a line-type ink jet head extending in a direction intersecting with a transport direction of a printing medium is described.

Note that the same reference sings are applied to the same portions as those of the third embodiment, and the description thereof is omitted.

As illustrated in FIG. 24, a printer 1 includes a flat-plate-shaped platen 2. A predetermined printing medium 3 is transported on an upper surface of the platen 2 in a sub-scanning direction by a paper feed motor 38 (not illustrated) serving as a printing-medium transport portion.

A support member 50 that extends in a direction intersecting with a transport direction of the printing medium 3 is provided above the platen 2. The support member 50 includes a linear ink jet head 11. The platen 2 may be provided with an ink discarding region for no-margin printing.

A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject liquid, for example, ink on the printing medium 3.

The ink jet head 11 includes a driving element 36 (not illustrated) such as a piezoelectric element for ejecting liquid from each of the nozzle holes 13. Also, an ink cartridge 15 that supplies the ink jet head 11 with ink is mounted on the support member 50.

The ink jet head 11, the ink cartridge 15, and the support member 50 are collectively called line-type ink jet head.

In this embodiment, an example of using a single-color ink cartridge 15 and using ink as the liquid is described. Alternatively, the ink cartridge 15 may be arranged at a location other than the support member 50.

The ink jet head 11 has side surfaces intersecting with the liquid ejection surface 12. Two plasma actuators 20 are arranged on side surfaces in the transport direction of the printing medium 3. Each plasma actuator 20 is longer than the nozzle row 14.

In this embodiment, each plasma actuator 20 is arranged at a position separated by a distance larger than the distance between the liquid ejection surface 12 of the nozzle row 14 and a recording surface of the printing medium 3.

The plasma actuators 20 are arranged to generate airflows toward the printing medium 3. Since the plasma actuators 20 generate the airflows toward the printing medium 3, an air curtain can be formed, and the movement of the air with the transport of the printing medium 3 can be suppressed.

The plasma actuators 20 may be arranged in a desirable manner as long as the plasma actuators 20 can generate airflows toward the printing medium 3.

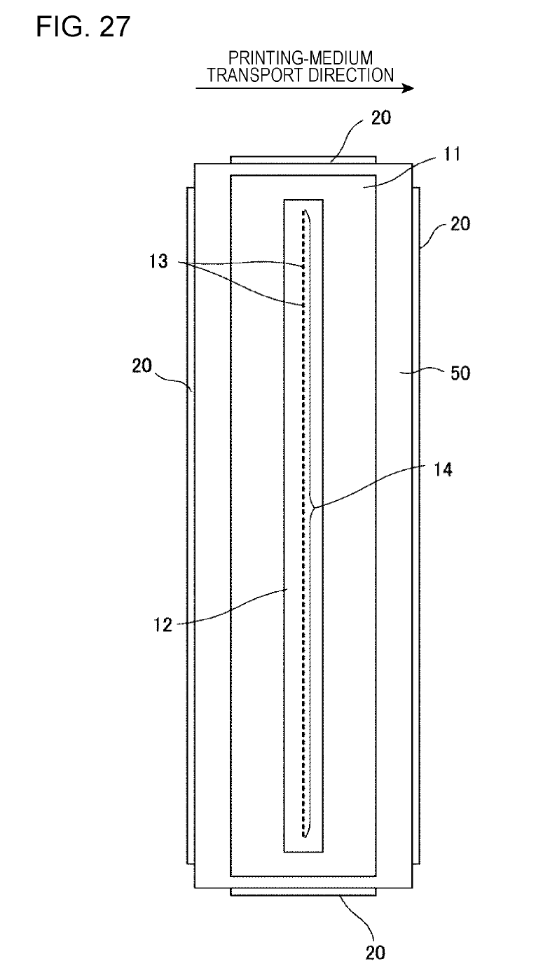

FIG. 27 illustrates a modification in which plasma actuators 20 are arranged also in a direction intersecting with the transport direction of the printing medium 3.

With this configuration, airflows can be generated toward the printing medium 3 also in the direction intersecting with the transport direction of the printing medium 3.

Alternatively, the plasma actuators 20 may be arranged only in the direction intersecting with the transport direction of the printing medium 3.

While the plasma actuators 20 are arranged on the single ink jet head 11 according to this embodiment, the invention is not limited thereto.

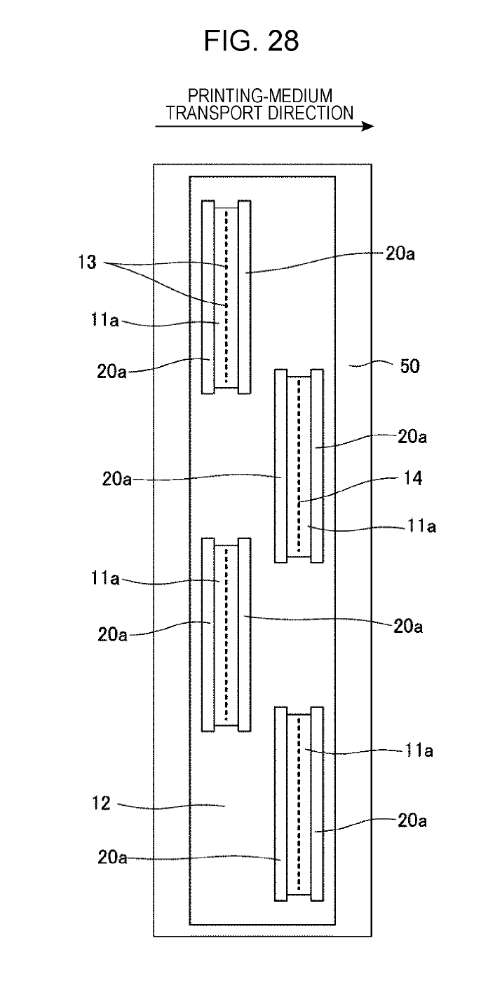

FIG. 28 illustrates an example in which an ink jet head 11 is configured of a plurality of unit ink jet heads 11a. As illustrated in FIG. 28, the unit ink jet heads 11a may be arranged in a staggered manner, and plasma actuators 20a may be arranged individually for the unit ink jet heads 11a.

In this case, among the unit ink jet heads 11a, a unit ink jet head 11a that ejects ink from the nozzle row 14 and a unit ink jet head 11a that does not eject ink from the nozzle row 14 may be present. In this case, the controller 30 may cause only a plasma actuator 20a corresponding to the unit ink jet head 11a that ejects ink to be driven.

Alternatively, the plasma actuators 20 may be arranged on each unit ink jet head 11a in a direction intersecting with the transport direction of the printing medium 3. Alternatively, the plasma actuators 20 may not be arranged individually for the unit ink jet heads 11a.

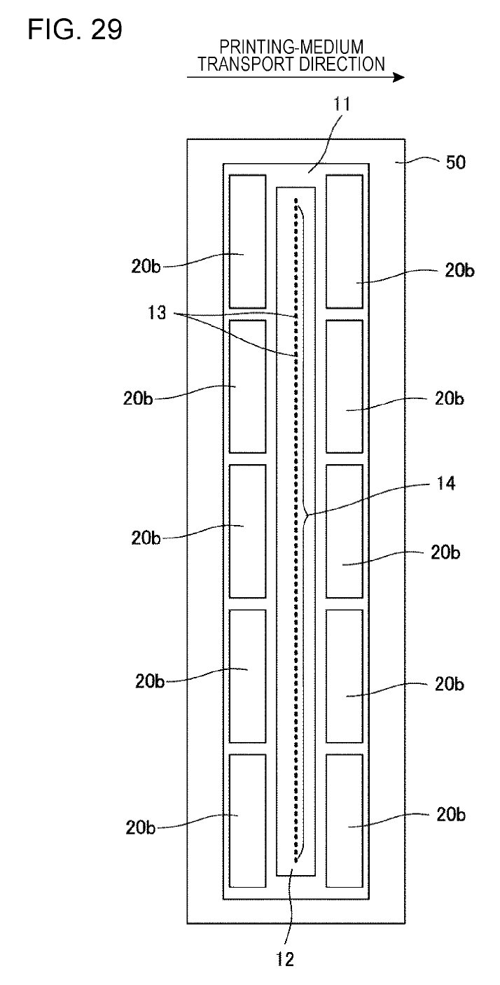

FIG. 29 illustrates an example in which each plasma actuator 20 is configured of a plurality of plasma actuators 20b arranged in line. As illustrated in FIG. 29, even when the plurality of plasma actuators 20b are arranged in line, similar advantages can be attained.

Also, in this case, in the ink jet head 11, the nozzle row 14 may include a nozzle hole 13 that ejects ink and a nozzle hole 13 that does not eject ink. In such a case, the controller 30 may cause only a plasma actuator 20b corresponding to the nozzle hole 13 that ejects ink to be driven.

Also, the plasma actuators 20 may be formed as a unit, and the unit may be arranged in a manner attachable to and detachable from the ink jet head 11 or the support member 50.

The printing method of this embodiment is similar to the printing method of any of the above-described embodiments and hence the description is omitted.

With the printing method of this embodiment, since the plasma actuators 20 are driven to generate the airflows toward the printing medium 3, an air curtain can be formed around the nozzle row 14 when ink is ejected from the nozzle row 14. By forming the air curtain in this way, the movement of the air with the movement of the printing medium 3 can be suppressed.

As described above, in the embodiment to which the invention is applied, the ink jet head 11 is a line-type ink jet head 11 extending in the direction intersecting with the transport direction of the printing medium 3.

Accordingly, by driving the plasma actuators 20 to generate airflows toward the printing medium 3, an air curtain can be formed, and when the line-type ink jet head 11 is used, the movement of the air with the movement of the printing medium 3 can be suppressed. Consequently, deviation of an ink-landing position can be reduced, and printing quality can be improved.

In an example of this embodiment, the ink jet head 11 has the liquid ejection surface 12 in which the nozzle row 14 is open and which faces the printing medium 3, and the side surfaces intersecting with the liquid ejection surface 12. The plasma actuators 20 may be arranged on the side surfaces in the transport direction of the printing medium 3.

Accordingly, since the plasma actuators 20 can generate the airflows toward the printing medium 3 at the side surfaces in the transport direction of the printing medium 3, an air curtain can be formed.

In an example of this embodiment, the plasma actuators 20 may be arranged on side surfaces intersecting with the transport direction of the printing medium 3.

Accordingly, since the plasma actuators 20 can generate the airflows toward the printing medium 3 at the side surfaces in the direction intersecting with the transport direction of the printing medium 3, an air curtain can be formed.

In an example of this embodiment, the plasma actuators 20 may be configured of a plurality of plasma actuators 20.

Accordingly, since the plurality of plasma actuators 20 are arranged, the plasma actuator 20 corresponding to the nozzle hole 13 that ejects ink can be individually driven.

In an example of this embodiment, the ink jet head 11 may be configured such that a plurality of unit ink jet heads 11a are arranged in a staggered manner.

Accordingly, the unit ink jet heads 11a can individually generate airflows toward the printing medium 3, and an air curtain can be formed.

In an example of this embodiment, the plasma actuators 20 may be arranged for each of the unit ink jet heads 11a.

Accordingly, since the plasma actuators 20 can be driven on the unit ink jet head 11a basis, an air curtain can be formed on the unit ink jet head 11a basis.

In an example of this embodiment, the controller 30 may individually control the plurality of plasma actuators 20 to drive the plasma actuator 20 corresponding to the nozzle hole 13 (nozzle) that is included in the nozzle row 14 and that ejects ink.

Accordingly, since the plasma actuator corresponding to the nozzle hole 13 that ejects liquid is driven, an air curtain can be formed around the nozzle hole 13 that ejects liquid.

### Fifth Embodiment

A fifth embodiment of the invention is described next.

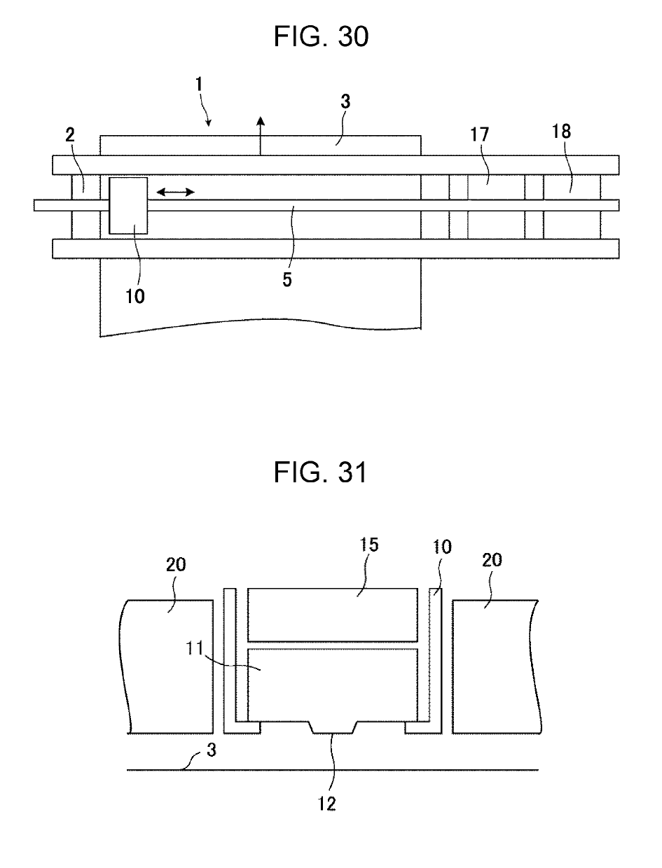

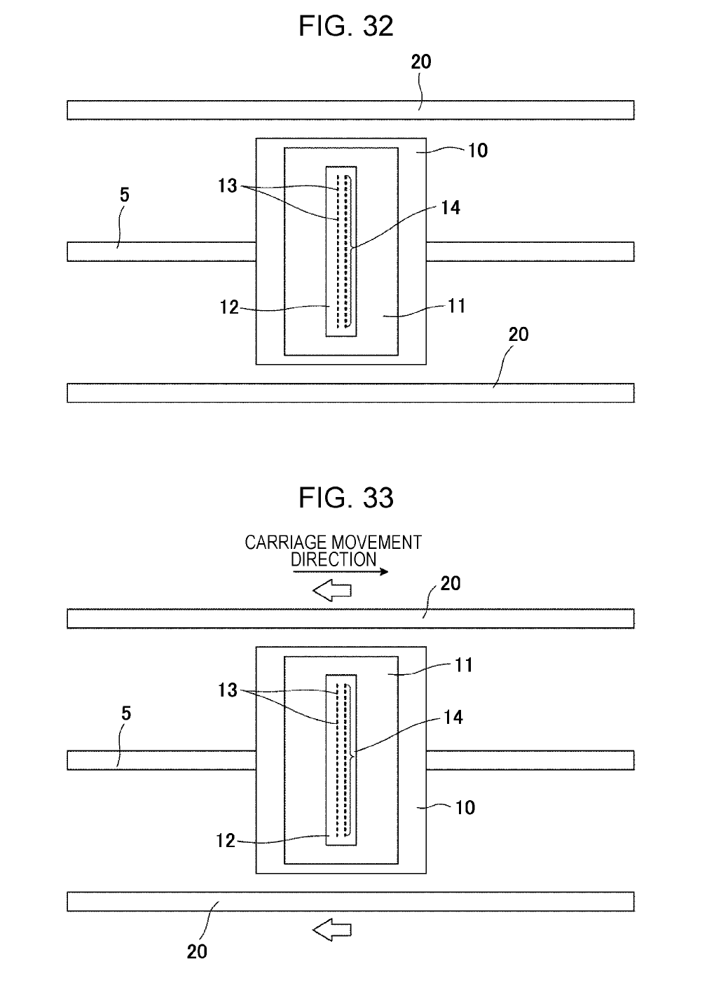

FIG. 30 is a schematic illustration of a printer according to the fifth embodiment. FIG. 31 is a schematic illustration of an ink jet head of the printer according to the fifth embodiment. FIG. 32 is a schematic illustration when viewed from a liquid ejection surface in FIG. 31. Described in the fifth embodiment is a case where a serial-type ink jet head mounted on a carriage that reciprocates in a main-scanning direction is used as an ink jet head.

Note that the same reference sings are applied to the same portions as those of any of the above-described embodiments, and the description thereof is omitted.

As illustrated in FIG. 30, a printer 1 includes a flat-plate-shaped platen 2. A predetermined printing medium 3 is transported on an upper surface of the platen 2 in a sub-scanning direction by a paper feed mechanism (not illustrated). The platen 2 may be provided with an ink discarding region for no-margin printing.

The printing medium 3 is similar to that of any of the above-described embodiments.

A guide shaft 5 that extends in a direction orthogonal to a transport direction of the printing medium 3 is provided above the platen 2. A carriage 10 is provided on the guide shaft 5 so that the carriage 10 can be driven to reciprocate along the guide shaft 5 via a driving mechanism (not illustrated).

An ink jet head 11 is mounted on the carriage 10. A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject liquid, for example, ink on the printing medium 3. In this embodiment, the nozzle row 14 includes two nozzle rows 14 formed in parallel to each other. In this case, a gap between the liquid ejection surface 12 and the platen 2, or a gap between the liquid ejection surface 12 and the printing medium 3 is generally called platen gap. An example of using ink as the liquid is described below.

The ink jet head 11 includes a driving element such as a piezoelectric element for ejecting liquid from each of the nozzle holes 13. Also, an ink cartridge 15 that supplies the ink jet head 11 with ink is mounted on the carriage 10.

The carriage 10, the ink jet head 11, and the ink cartridge 15 are collectively called ink jet head. In this embodiment, an example of using a single-color ink cartridge 15 is described. Alternatively, the ink cartridge 15 may be arranged at a location other than the carriage 10.

A flushing area 17 of the ink jet head 11 is provided on one side of the platen 2. By ejecting ink from the nozzle holes 13 of the ink jet head 11 to the flushing area 17, ink increased in viscosity is discharged. A gap between the flushing area 17 and the liquid ejection surface 12 is also called platen gap.

A cleaning area 18 including a cap (not illustrated) is provided on one side of the flushing area 17. By ejecting ink in the cleaning area 18 while the cap is attached so as to cover the nozzle rows 14 of the ink jet head 11, the nozzle holes 13 are cleaned.

Two plasma actuators 20 extending along the guide shaft 5 are arranged on both sides of the guide shaft 5 in a transport direction of the printing medium 3 with the ink jet head 11 interposed therebetween.

The plasma actuators 20 extend in a movement direction of the ink jet head 11, and are arranged in a movable range of at least the ink jet head 11.

The basic structure of each plasma actuator 20 is similar to the above-described embodiment illustrated in FIG. 4. Hence, by adjusting the arrangement of two electrodes 21a and 21b, an airflow can be generated in a desirable direction. By controlling application of the alternating voltage, the plasma actuator 20 can be easily controlled for generation and stop of an airflow, or an airflow rate. This feature is not easily provided by an airflow generating device such as a fan. Alternatively, two electrodes 21b may be prepared and arranged such that an electrode 21a is interposed between the electrodes 21b. Thus, an airflow generation direction can be controlled in forward and reverse directions by selecting one of the two electrodes 21b. Alternatively, two electrodes 21a may be prepared and arranged such that an electrode 21b is interposed between the electrodes 21a. By simultaneously driving the two electrodes 21a, airflows generated by the two plasma actuators collide with each other at the electrode 21b, and generate airflows in a direction intersecting with the surface where the electrodes are arranged.

The plasma actuators 20 are arranged to generate airflows in the movement direction of the ink jet head 11. The plasma actuators 20 are configured of, for example, a plurality of plasma actuators 20 alternately arranged so that airflow generation directions of the plasma actuators 20 are opposite to each other.

With this configuration, airflows can be generated on both sides of the ink jet head 11, to either of both directions in the movement direction of the ink jet head 11.

FIG. 33 illustrates an example of generating airflows in a direction opposite to the movement direction of the ink jet head 11 by the driving of the plasma actuators 20.

As illustrated in FIG. 33, the plasma actuators 20 generate airflows in the direction opposite to the movement direction of the ink jet head 11.

By generating the airflows in this way, the air in the platen gap likely moves with the movement of the carriage 10, and a mist around the liquid ejection surface 12 is discharged. A Karman vortex is generated in the rear of the carriage 10 in the movement direction; however, by driving the plasma actuators 20 in this way, the generation of a Karman vortex can be suppressed. Thus, random diffusion of a mist into a casing of the printer 1 due to a Karman vortex can be reduced.

FIG. 33 illustrates an example when the ink jet head 11 moves rightward in the drawing; however, when the ink jet head 11 moves in the opposite direction, the plasma actuators 20 also reverse the direction of airflows.

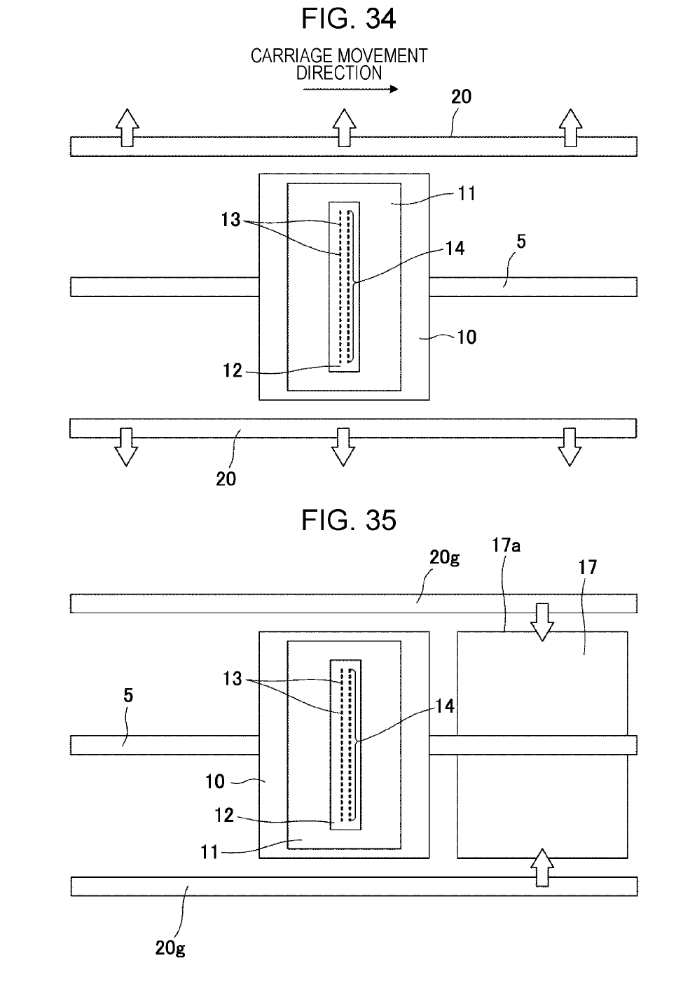

FIG. 34 illustrates an example of generating airflows in a direction intersecting with the movement direction of the ink jet head by the driving of the plasma actuators 20.

As illustrated in FIG. 34, when the carriage 10 with the ink jet head 11 mounted moves in the movement direction, the plasma actuators 20 generate airflows away from the ink jet head 11.

By generating the airflows in this way, the air in the platen gap likely moves with the movement of the carriage 10, and a mist around the liquid ejection surface 12 can be discharged in a direction orthogonal to the movement direction of the carriage 10.

Alternatively, airflows toward the carriage 10 may be generated by driving the plasma actuators 20 in the reverse manner to FIG. 34.

FIG. 35 illustrates an example of generating airflows in the flushing area.

As illustrated in FIG. 35, when the ink jet head 11 moves to the flushing area 17 and performs flushing, flushing-area plasma actuators 20g are driven to generate airflows toward an ink recovery box 17a of the flushing area 17.

Mists are more generated during the flushing operation when the adjacent nozzle rows 14 are simultaneously driven. In related art, the flushing operation has been executed while the adjacent nozzle rows 14 are not simultaneously driven. In this embodiment, by driving the flushing-area plasma actuators 20g during the flushing operation, a mist is recovered by using the airflows toward the ink recovery box 17a. Flushing can be executed simultaneously for all nozzle rows 14, and throughput can be increased.

Alternatively, the flushing-area plasma actuators 20g may generate airflows in a direction perpendicular to the paper face of FIG. 35.

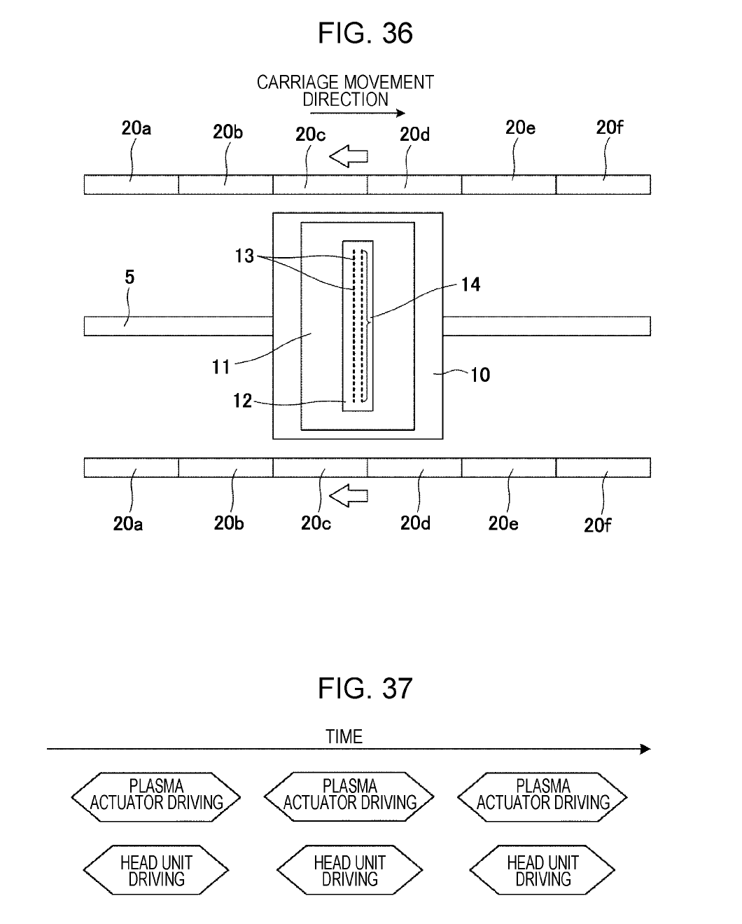

FIG. 36 illustrates an example in which each plasma actuator 20 is configured of a plurality of unit plasma actuators 20a to 20f arranged in line.

As illustrated in FIG. 36, the unit plasma actuators 20a to 20f generate airflows in a direction opposite to the movement direction of the carriage 10.

By generating the airflows in this way, the air in the platen gap likely moves with the movement of the carriage 10, and a mist around the liquid ejection surface 12 is discharged.

Also, by arranging the plurality of unit plasma actuators 20a to 20f in line, the unit plasma actuators 20a to 20f can be selectively driven in accordance with the movement of the carriage 10.

For example, when the carriage 10 is moved in the movement direction of the carriage 10, in FIG. 36, the unit plasma actuator 20e located directly in front of the ink jet head 11 in the movement direction of the carriage 10 may be driven. When the carriage 10 is moved in the direction opposite to the movement direction, the unit plasma actuator 20b located directly behind the ink jet head 11 may be driven.

A mist likely stays in the direction opposite to the movement direction of the ink jet head 11. Thus, the driving of the plasma actuators 20 may be increased, and the flow amount may be increased.

Also, the plasma actuators 20 may be formed as a unit, and the unit may be arranged in an attachable and detachable manner.

The control configuration of this embodiment and the driving timings of the plasma actuators 20 are similar to the control configuration (see FIG. 8) of the above-described embodiment and the driving timings (see FIG. 9), and therefore the description is omitted.

FIG. 37 is a timing chart illustrating driving timings of the plasma actuators 20 when plural printing timings of the ink jet head 11 are present in one passage of the carriage 10.

As illustrated in FIGS. 9 and 37, for example, in comparison to a timing at which the driving element 36 of the ink jet head 11 is driven and ink is ejected, the controller 30 performs control to start the driving of the plasma actuator 20 earlier than the ejection start of ink. Also, the controller 30 performs control to end the driving of the plasma actuator 20 later than the ejection end of ink.

Also in this embodiment, by driving the plasma actuators 20 earlier than the ejection start of ink as described above like the timing chart illustrated in FIGS. 9 and 37, airflows can be generated before ink is ejected. By ending the driving of the plasma actuator 20 later than the ejection end of ink, a mist staying during printing can be discharged.

The printing method of this embodiment is similar to the printing method of any of the above-described embodiments and hence the description is omitted.

With the printing method of this embodiment, since the airflows are generated by driving the plasma actuators 20, the air in the platen gap likely moves with the movement of the carriage 10, and a mist around the liquid ejection surface 12 can be discharged.

Also, as illustrated in FIG. 36, when the plurality of unit plasma actuators 20a to 20f are arranged, the controller 30 controls the unit plasma actuators 20a to 20f to be driven in accordance with the movement of the carriage 10.

As described above, the printer 1 according to the embodiment to which the invention is applied includes the ink jet head 11 that ejects liquid from the nozzle rows 14 being open in the liquid ejection surface 12 arranged on the surface facing the printing medium 3. Also, the printer 1 includes the plasma actuator 20 provided separately from the ink jet head 11, and the controller 30 that controls the ink jet head 11 and the plasma actuator 20. The controller 30 drives the plasma actuator 20 to generate an airflow for discharging a mist, which is generated when the nozzle rows 14 eject liquid, from an area between the liquid ejection surface 12 and the printing medium 3.

Accordingly, since the airflow is generated by driving the plasma actuator 20, the air in the platen gap likely moves with the movement of the ink jet head 11, and a mist of the liquid ejection surface 12 can be discharged. Thus, a mist unlikely adheres to the liquid ejection surface 12, and occurrence of a misprint can be reduced. Also, since the plasma actuator 20 is provided, a large-scale airflow generating device is not additionally required, and facilitation cost can be reduced.

In an example of this embodiment, the ink jet head 11 may be a serial-type ink jet head 11 that reciprocates in a main-scanning direction.

Accordingly, in the serial-type ink jet head 11 that reciprocates in the main-scanning direction, a mist around the liquid ejection surface 12 can be efficiently discharged.

Also, in this embodiment, the plasma actuator 20 may be arranged in the movement direction of the ink jet head 11.

Accordingly, when the ink jet head 11 reciprocates, a mist can be discharged.

In an example of this embodiment, the plasma actuator 20 may generate an airflow in the movement direction of the ink jet head 11.

Accordingly, an airflow can be generated in the movement direction of the ink jet head 11, and when the ink jet head 11 reciprocates, a mist can be discharged in the movement direction of the ink jet head 11.

In an example of this embodiment, the plasma actuator 20 may generate an airflow in a direction intersecting with the movement direction of the ink jet head 11.

Accordingly, an airflow can be generated in the direction intersecting with the movement direction of the ink jet head 11, and a mist can be discharged in the direction intersecting with the movement direction of the ink jet head 11.

In an example of this embodiment, the plasma actuator 20 may be configured such that the plurality of unit plasma actuators 20a to 20f are arranged in line in the movement direction of the ink jet head 11.

Accordingly, the unit plasma actuators 20a to 20f can be driven in accordance with the movement of the ink jet head 11.

In an example of this embodiment, the controller 30 may drive the unit plasma actuators 20a to 20f in accordance with the reciprocation of the ink jet head 11.

Accordingly, the unit plasma actuators 20a to 20f can be selectively driven as required in accordance with the reciprocation of the ink jet head 11.

In an example of this embodiment, the plasma actuator 20 may generate an airflow in the reciprocation direction of the ink jet head 11, and the controller 30 may reverse the airflow direction in accordance with the reciprocation of the ink jet head 11.

Accordingly, the plasma actuator 20 can generate the airflow in accordance with the reciprocation of the ink jet head 11.

In an example of this embodiment, the flushing area 17 that executes the flushing operation of the ink jet head 11, and the flushing-area plasma actuator 20g arranged in the flushing area 17 are further provided. The flushing-area plasma actuator 20g may generate an airflow in a direction so that a mist generated during flushing is directed toward the ink recovery box 17a of the flushing area 17.

Accordingly, by driving the flushing-area plasma actuator 20g, a mist generated during flushing can be discharged to the ink recovery box 17a of the flushing area 17. Also, flushing can be executed simultaneously for all nozzle rows 14, and throughput can be increased.

### Sixth Embodiment

A sixth embodiment of the invention is described next.

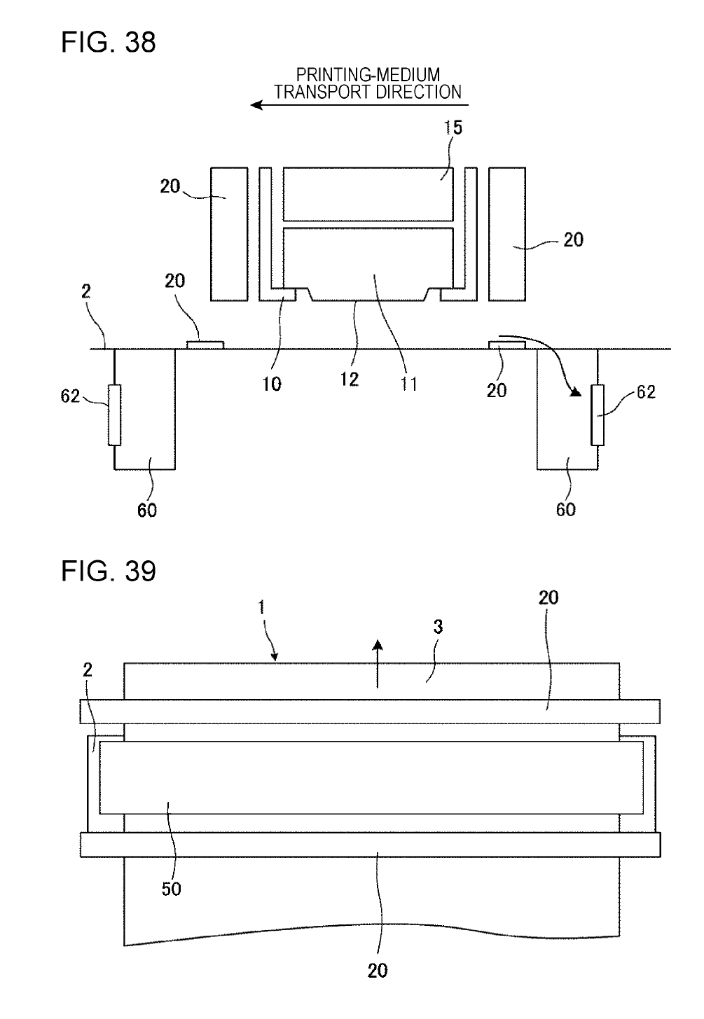

FIG. 38 is a schematic illustration of an ink jet head according to the sixth embodiment of the invention. Note that the same reference sings are applied to the same portions as those of the fifth embodiment, and the description thereof is omitted.

As illustrated in FIG. 38, mist recovery containers 60 are provided below the platen 2, on both sides of the ink jet head 11 in the transport direction of the printing medium 3. Each mist recovery container 60 is open in the platen 2.

A filter 62 that recovers a mist sent into the mist recovery container 60 is arranged in the mist recovery container 60. The filter 62 is attachable and detachable.

A plasma actuator 20 that generates an airflow to recover a mist in the platen gap is arranged on the platen 2.

In this embodiment, the plasma actuator 20 is driven when the carriage 10 is moved. Accordingly, an airflow flowing toward the mist recovery container 60 is generated in the mist recovery container 60 as indicated by an arrow in the drawing. With this airflow, a mist generated from the nozzle rows 14 enters the mist recovery container 60, and is recovered by the filter 62.

As described above, in this embodiment, the filter 62 that recovers a mist is provided on the downstream side of the airflow generated by the plasma actuator 20.

Accordingly, by driving the plasma actuator 20, a mist generated from the nozzle rows 14 can be recovered by the filter 62.

While the filter 62 is attachable and detachable in the sixth embodiment, the invention is not limited thereto. For example, the mist recovery container 60 can be entirely exchanged.

### Seventh Embodiment

A seventh embodiment of the invention is described next.

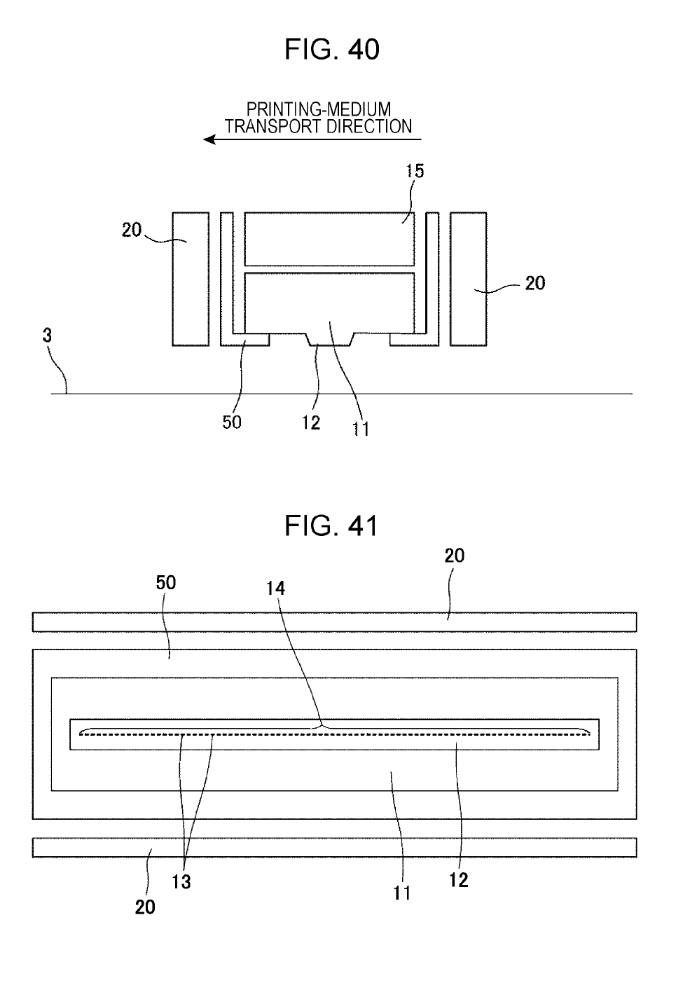

FIG. 39 is a schematic illustration of a printer according to the seventh embodiment. FIG. 40 is a schematic illustration of an ink jet head of the printer according to the seventh embodiment. FIG. 41 is a schematic illustration when viewed from a liquid ejection surface in FIG. 40. In the seventh embodiment, a case of using a line-type ink jet head extending in a direction intersecting with a transport direction of a printing medium is described. Note that the same reference sings are applied to the same portions as those of any of the above-described embodiments, and the description thereof is omitted. Also, the control configuration is described with reference to FIG. 8.

As illustrated in FIG. 39, a printer 1 includes a flat-plate-shaped platen 2. A predetermined printing medium 3 is transported on an upper surface of the platen 2 in a sub-scanning direction by a paper feed motor 38.

A support member 50 that extends in a direction intersecting with a transport direction of the printing medium 3 is provided above the platen 2. The support member 50 includes a linear ink jet head 11. The platen 2 may be provided with an ink discarding region for no-margin printing.

A surface of the ink jet head 11 facing the platen 2 is a liquid ejection surface 12. The liquid ejection surface 12 has a nozzle row 14 being open in the liquid ejection surface 12. The nozzle row 14 includes a plurality of nozzle holes 13 that eject ink on the printing medium 3.

The ink jet head 11 includes a driving element 36 such as a piezoelectric element for ejecting liquid from each of the nozzle holes 13. Also, an ink cartridge 15 that supplies the ink jet head 11 with ink is mounted on the support member 50.

The ink jet head 11, the ink cartridge 15, and the support member 50 are collectively called line-type ink jet head.

In this embodiment, an example of using a single-color ink cartridge 15 and using ink as the liquid is described. Alternatively, the ink cartridge 15 may be arranged at a location other than the support member 50.

For example, a flushing area 17 of the ink jet head 11 is provided below the platen 2. The platen 2 is retractable from a position below the ink jet head 11. While the platen 2 is retracted, by ejecting ink from the nozzle holes 13 of the ink jet head 11, ink increased in viscosity is discharged in the flushing area 17.

Also, two plasma actuators 20 are arranged on both sides of the ink jet head 11 in the transport direction of the printing medium 3. The plasma actuators 20 are arranged in a direction intersecting with the transport direction of the printing medium 3.

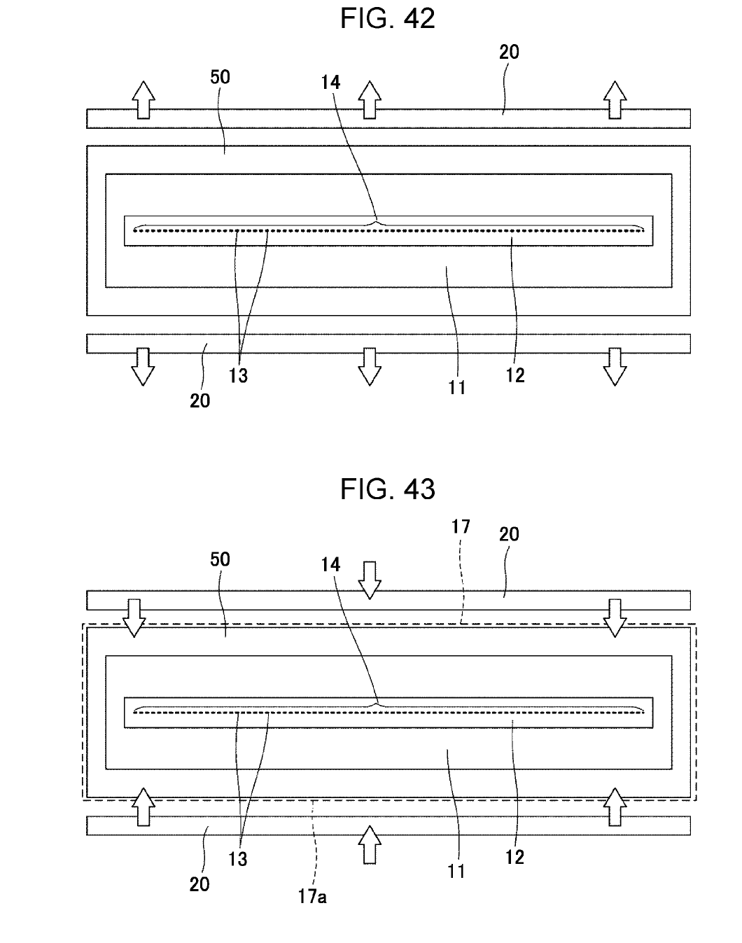

FIG. 42 illustrates an example in which the plasma actuators 20 generate airflows.

As illustrated in FIG. 42, the plasma actuators 20 are arranged to generate airflows in the transport direction of the printing medium 3. In this embodiment, the plasma actuators 20 are configured of two plasma actuators 20 arranged so that airflow generation directions of the plasma actuators 20 are opposite to each other.

With this configuration, airflows can be generated on both sides of the ink jet head 11, to either of both sides in the transport direction of the printing medium 3.

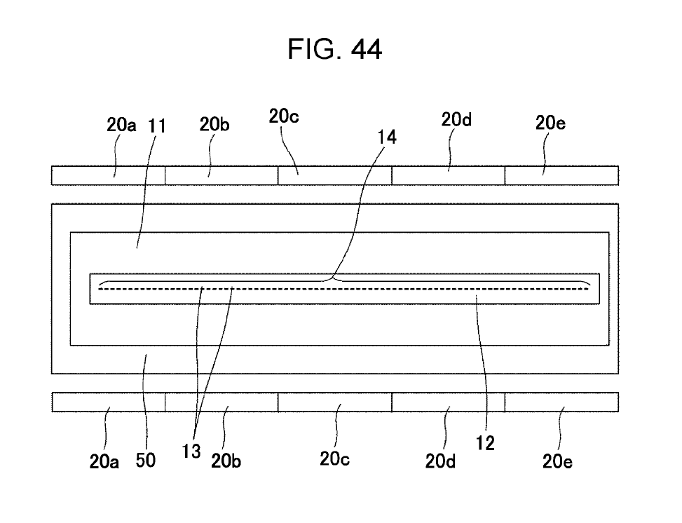

FIG. 43 illustrates an example of generating airflows in the flushing area.

As illustrated in FIG. 43, when flushing is performed in the flushing area 17 while the platen 2 is retracted from the position below the ink jet head 11, the plasma actuators 20 are driven. In this case, the plasma actuators 20 generate airflows toward the ink jet head 11.

Accordingly, by driving the plasma actuators 20, a mist generated during flushing can be discharged to an ink recovery box 17a of the flushing area 17.

Alternatively, the plasma actuators 20 may generate airflows in a direction perpendicular to the paper face of FIG. 43.

FIG. 44 illustrates an example in which each plasma actuator 20 is configured of a plurality of unit plasma actuators 20a to 20e arranged in line.

As illustrated in FIG. 44, the unit plasma actuators 20a to 20e generate airflows on both sides in the transport direction of the printing medium 3.

By generating the airflows in this way, the air in the platen gap likely moves, and a mist around the liquid ejection surface 12 is discharged.

Also, by arranging the plurality of unit plasma actuators 20a to 20e in line, the unit plasma actuators 20a to 20e can be individually driven.

For example, with the controller 30, the unit plasma actuators 20a to 20e are driven in accordance with the width dimension of the printing medium 3. That is, by driving the unit plasma actuators 20a to 20e in a region where the printing medium 3 is present, airflows can be generated only in a region where ink is ejected.

The printing method of this embodiment is similar to the printing method of any of the above-described embodiments and hence the description is omitted.

With the printing method of this embodiment, by driving the plasma actuators 20 to generate the airflows toward the printing medium 3, a mist around the liquid ejection surface 12 can be discharged.

As described above, in the embodiment to which the invention is applied, the ink jet head 11 is a line-type ink jet head extending in the direction intersecting with the transport direction of the printing medium 3.

Accordingly, by driving the plasma actuators 20 and generating airflows, the air in the platen gap likely moves with the transport of the printing medium 3, and a mist around the liquid ejection surface 12 can be discharged. Thus, a mist unlikely adheres to the liquid ejection surface 12, and occurrence of a misprint can be reduced. Also, since the plasma actuators 20 are provided, a large-scale airflow generating device is not additionally required, and facilitation cost can be reduced.

In an example of this embodiment, plasma actuators 20 may be arranged in a direction intersecting with the transport direction of the printing medium 3.

Accordingly, with the line-type ink jet head 11, the plasma actuators 20 can discharge a mist around the liquid ejection surface 12.

In an example of this embodiment, the plasma actuators 20 may generate airflows in the transport direction of the printing medium 3.

Accordingly, by driving the plasma actuators 20, airflows in the transport direction of the printing medium 3 can be generated, and a mist around the liquid ejection surface 12 can be discharged.

In an example of this embodiment, the plasma actuators 20 each may be configured such that the plurality of unit plasma actuators 20a to 20e are arranged in line in a direction intersecting with the transport direction of the printing medium 3.

Accordingly, since the plurality of unit plasma actuators 20a to 20e are arranged, only at least one of the unit plasma actuators 20a to 20e corresponding to the nozzle that ejects ink can be individually driven.

In an example of this embodiment, the controller 30 may drive the unit plasma actuators 20a to 20e in accordance with the width dimension of the printing medium 3.

Thus, by individually driving the unit plasma actuators 20a to 20e in the region where the printing medium 3 is present, airflows can be generated only in a range of the printing medium 3 where ink is ejected.

The above-described embodiments are merely examples of specific modes to which the invention is applied, and it is not intended to limit the invention. The invention can be applied to a mode different from the above-described embodiments.

### REFERENCE SIGNS LIST

1 printer
2 platen
3 printing medium
5 guide shaft
10 carriage
11 ink jet head
12 liquid ejection surface
13 nozzle hole
14 nozzle row
15 ink cartridge
20 plasma actuator
30 controller
40 driving voltage generator
52 filter

1. A printer, comprising:
an ink jet head that ejects liquid from a nozzle row being open in a liquid ejection surface arranged on a surface facing a printing medium;
a plasma actuator; and
a controller that controls the ink jet head and the plasma actuator,
wherein, when the nozzle row ejects the liquid to the printing medium, the controller drives the plasma actuator to generate an airflow between the liquid ejection surface and the printing medium.

2. The printer according to claim 1, wherein the ink jet head is a serial-type ink jet head mounted on a carriage that reciprocates in a main-scanning direction.

3. The printer according to claim 2, wherein the plasma actuator is arranged beside the nozzle row in a movement direction of the ink jet head.

4. The printer according to claim 2, wherein the plasma actuator is arranged beside the nozzle row in a direction intersecting with a movement direction of the ink jet head.

5. The printer according to claim 2,
wherein the ink jet head has a side surface intersecting with the liquid ejection surface,
wherein the plasma actuator is arranged on the side surface in a movement direction of the ink jet head, and
wherein, when the nozzle row ejects the liquid, the controller drives the plasma actuator to generate an airflow in a direction from the ink jet head toward the printing medium.

6. The printer according to claim 1, wherein the ink jet head is a line-type ink jet head extending in a direction intersecting with a transport direction of the printing medium.

7. The printer according to claim 6, wherein the plasma actuator is arranged beside the nozzle row in the transport direction of the printing medium.

8. The printer according to claim 6, wherein the plasma actuator is arranged beside the nozzle row in the direction intersecting with the transport direction of the printing medium.

9. The printer according to claim 6, wherein the plasma actuator includes a plurality of plasma actuators.

10. The printer according to claim 6, wherein the line-type ink jet head is configured such that a plurality of unit ink jet heads are arranged in a staggered manner.

11. The printer according to claim 10, wherein the plasma actuator is arranged for each of the unit ink jet heads.

12. The printer according to claim 6,
wherein the ink jet head has a side surface intersecting with the liquid ejection surface,
wherein the plasma actuator is arranged on the side surface in the transport direction of the printing medium, and
wherein, when the nozzle row ejects the liquid, the controller drives the plasma actuator to generate an airflow in a direction from the ink jet head toward the printing medium.

13. The printer according to claim 1, wherein the plasma actuator is arranged at a position at a distance larger than a distance between the liquid ejection surface and a recording surface of the printing medium.

14. The printer according to claim 1, further comprising:
a driving voltage generator that generates a driving voltage for driving the plasma actuator, and
wherein the driving voltage generator is mounted on the ink jet head.

15. The printer according to claim 14,
wherein the ink jet head includes wiring for supplying an ink jet driving voltage for driving the ink jet head, and
wherein the driving voltage generator generates a voltage for driving the plasma actuator by using the ink jet driving voltage supplied via the wiring.

16. The printer according to claim 6, wherein the controller individually controls the plurality of plasma actuators to drive a plasma actuator corresponding to a nozzle that is included in the nozzle row and that ejects the liquid.

17. The printer according to claim 1, wherein the plasma actuator is mounted on the ink jet head.

18. The printer according to claim 1, wherein the plasma actuator is arranged separately from the ink jet head.

19. A printing method comprising, when a nozzle row being open in a liquid ejection surface of an ink jet head ejects liquid to a printing medium, driving a plasma actuator to generate an airflow between the liquid ejection surface and the printing medium.

20. An ink jet head, comprising:
a liquid ejection surface arranged on a surface facing a printing medium;
a nozzle row that is open in the liquid ejection surface, and that ejects liquid to the printing medium; and
a plasma actuator,
wherein, when the nozzle row ejects the liquid to the printing medium, the plasma actuator generates an airflow between the liquid ejection surface and the printing medium.
